(19) United States
(12) Patent Application Publication
(10) Pub. No.: US 2023/0252736 A1
(43) Pub. Date: Aug. 10, 2023

(54) METHOD AND DEVICE FOR SURFACING A VIRTUAL OBJECT CORRESPONDING TO AN ELECTRONIC MESSAGE

(71) Applicant: Apple Inc., Cupertino, CA (US)

(72) Inventors: Elizabeth V. Petrov, Princeton, NJ (US); Ioana Negoita, San Jose, CA (US)

(21) Appl. No.: 18/101,147

(22) Filed: Jan. 25, 2023

Related U.S. Application Data
(60) Provisional application No. 63/308,555, filed on Feb. 10, 2022.

(51) Int. Cl. G06T 19/00; H04N 5/265; G06V 10/764; H04L 51/046; H04L 51/08

(52) U.S. Cl. CPC G06T 19/006; H04N 5/265; G06V 10/764; H04L 51/046; H04L 51/08; G06V 2201/07

(57) ABSTRACT

In one implementation, a method for surfacing an XR object corresponding to an electronic message. The method includes: obtaining an electronic message from a sender; in response to determining that the electronic message is associated with a real-world object, determining whether a current field-of-view (FOV) of a physical environment includes the real-world object; and in accordance with a determination that the current FOV of the physical environment includes the real-world object, presenting, via the display device, an extended reality (XR) object that corresponds to the electronic message in association with the real-world object.

### CROSS-REFERENCE TO RELATED APPLICATIONS

This application is claims priority to U.S. Provisional Patent App. No. 63/308,555, filed on Feb. 10, 2022, which is hereby incorporated by reference in its entirety.

### TECHNICAL FIELD

The present disclosure generally relates to presenting virtual objects and, in particular, to systems, devices, and methods for surfacing a virtual object corresponding to an electronic message.

### BACKGROUND

Ordinary text messages or emails that include instructions associated with a real-world object are not self-executory and, instead, rely on the reading comprehension and memory retention of the recipient to carry out the instructions. As such, ordinary text messages or emails are disassociated from the real-world or physical object.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating architecture in accordance with some implementations.

FIG. 2 is a block diagram of an example controller in accordance with some implementations.

FIG. 3 is a block diagram of an example electronic device in accordance with some implementations.

FIG. 4A is a block diagram of a first portion of an example content delivery architecture in accordance with some implementations.

FIG. 4B illustrates example data structures in accordance with some implementations.

FIG. 4C is a block diagram of a second portion of the example content delivery architecture in accordance with some implementations.

FIGS. 5A-5E illustrate a first sequence of instances associated with sending an electronic message associated with a real-world object in accordance with some implementations.

FIGS. 5F-5J illustrate a second sequence of instances associated with sending an electronic message associated with a real-world object in accordance with some implementations.

FIG. 6A illustrates an instance associated with receiving an electronic message associated with a real-world object in accordance with some implementations

FIG. 6B-6D illustrate a sequence of instances associated with surfacing an extended reality (XR) object that corresponds to the electronic message in association with the real-world object in accordance with some implementations.

FIG. 7 illustrates a flowchart representation of a method of surfacing an XR object corresponding to an electronic message in accordance with some implementations.

FIG. 8 illustrates a flowchart representation of a method of sending an electronic message associated with a real-world object in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### SUMMARY

Various implementations disclosed herein include devices, systems, and methods for surfacing an XR object corresponding to an electronic message. According to some implementations, the method is performed at a computing system including non-transitory memory and one or more processors, wherein the computing system is communicatively coupled to a display device and one or more input devices. The method includes: obtaining an electronic message from a sender; in response to determining that the electronic message is associated with a real-world object, determining whether a current field-of-view (FOV) of a physical environment includes the real-world object; and in accordance with a determination that the current FOV of the physical environment includes the real-world object, presenting, via the display device, an extended reality (XR) object that corresponds to the electronic message in association with the real-world object.

Various implementations disclosed herein include devices, systems, and methods for sending an electronic message associated with a real-world object. According to some implementations, the method is performed at a computing system including non-transitory memory and one or more processors, wherein the computing system is communicatively coupled to a display device and one or more input devices. The method includes: obtaining an alphanumeric string that corresponds to content for a new electronic message; obtaining metadata associated with a real-world object that is associated with the content; obtaining one or more recipients for the new electronic message; generating the new electronic message based on the alphanumeric string that corresponds to content for the new electronic message and the metadata associated with the real-world object that is associated with the content; and transmitting the new electronic message to the one or more recipients.

In accordance with some implementations, an electronic device includes one or more displays, one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more displays, one or more processors, a non-transitory memory, and means for performing or causing performance of any of the methods described herein.

In accordance with some implementations, a computing system includes one or more processors, non-transitory memory, an interface for communicating with a display device and one or more input devices, and one or more programs; the one or more programs are stored in the non-transitory memory and configured to be executed by the one or more processors and the one or more programs include instructions for performing or causing performance of the operations of any of the methods described herein. In accordance with some implementations, a non-transitory computer readable storage medium has stored therein instructions which when executed by one or more processors of a computing system with an interface for communicating with a display device and one or more input devices, cause the computing system to perform or cause performance of the operations of any of the methods described herein. In accordance with some implementations, a computing system includes one or more processors, non-transitory memory, an interface for communicating with a display device and one or more input devices, and means for performing or causing performance of the operations of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

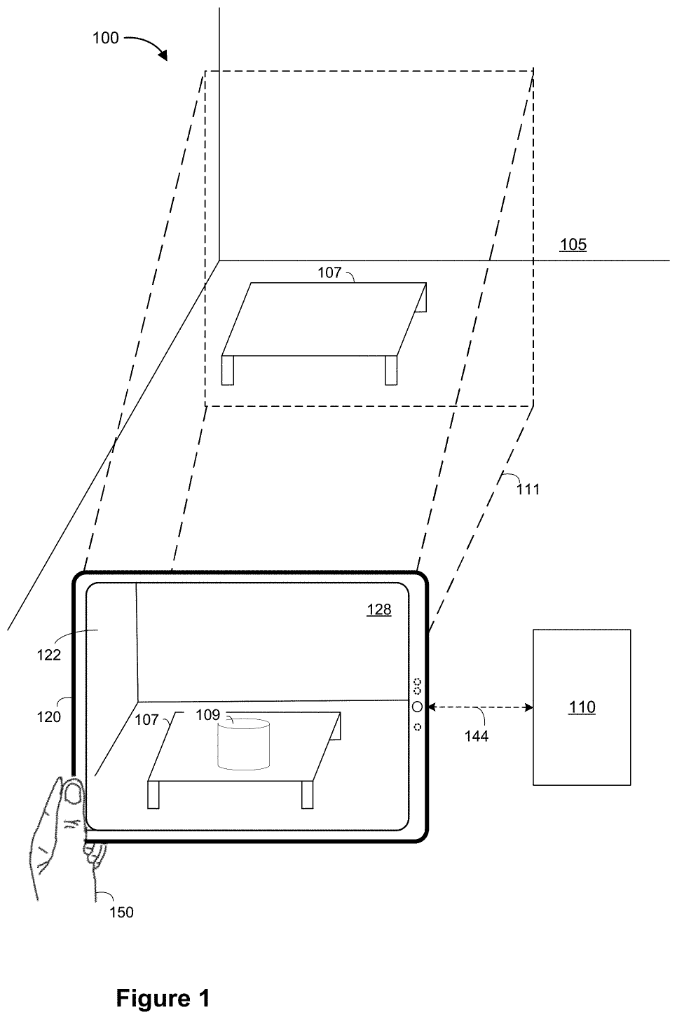

FIG. 1 is a block diagram of an example operating architecture 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating architecture 100 includes an optional controller 110 and an electronic device 120 (e.g., a tablet, mobile phone, laptop, near-eye system, wearable computing device, or the like).

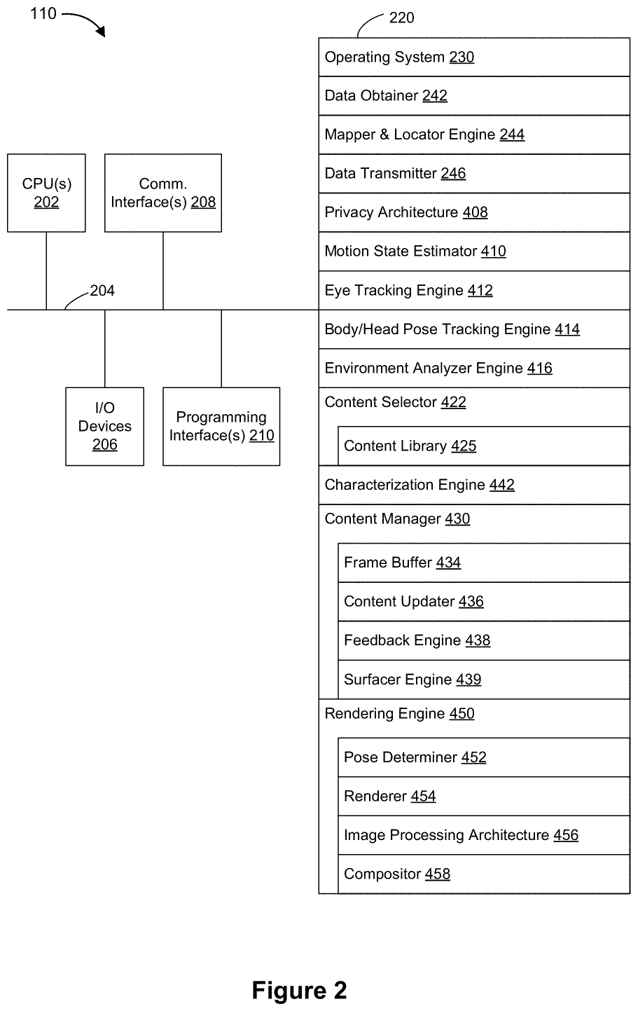

In some implementations, the controller 110 is configured to manage and coordinate an XR experience (sometimes also referred to herein as a “XR environment” or a “virtual environment” or a “graphical environment”) for a user 150 and optionally other users. In some implementations, the controller 110 includes a suitable combination of software, firmware, and/or hardware. The controller 110 is described in greater detail below with respect to FIG. 2. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In some implementations, the functions of the controller 110 are provided by the electronic device 120. As such, in some implementations, the components of the controller 110 are integrated into the electronic device 120.

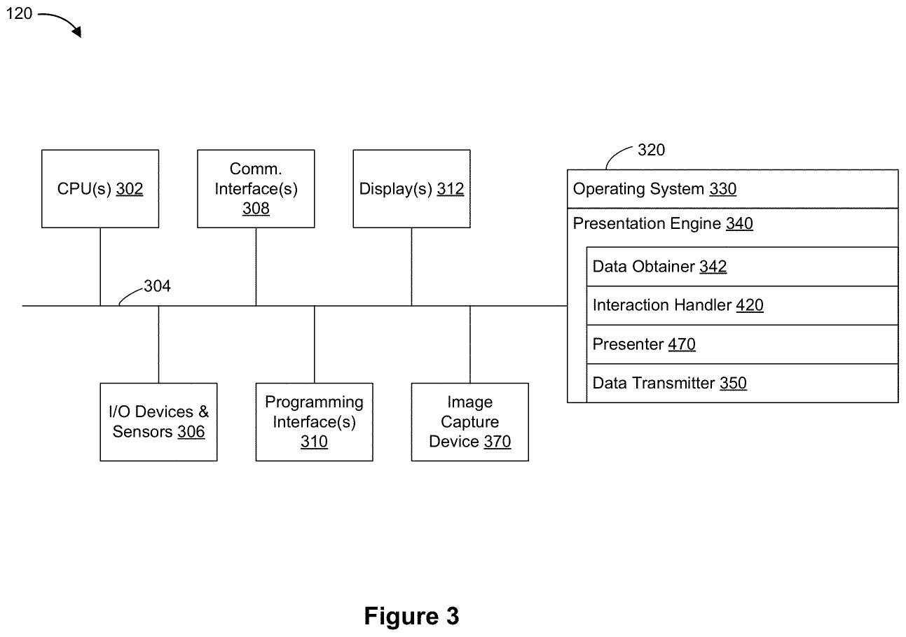

In some implementations, the electronic device 120 is configured to present audio and/or video (A/V) content to the user 150. In some implementations, the electronic device 120 is configured to present a user interface (UI) and/or an XR environment 128 to the user 150. In some implementations, the electronic device 120 includes a suitable combination of software, firmware, and/or hardware. The electronic device 120 is described in greater detail below with respect to FIG. 3.

According to some implementations, the electronic device 120 presents an XR experience to the user 150 while the user 150 is physically present within a physical environment 105 that includes a table 107 and a portrait 523 within the field-of-view (FOV) 111 of the electronic device 120. As such, in some implementations, the user 150 holds the electronic device 120 in his/her hand(s). In some implementations, while presenting the XR experience, the electronic device 120 is configured to present XR content (sometimes also referred to herein as “graphical content” or “virtual content”), including an XR cylinder 109, and to enable video pass-through of the physical environment 105 (e.g., including the table 107 and the portrait 523 (or representations thereof)) on a display 122. For example, the XR environment 128, including the XR cylinder 109, is volumetric or three-dimensional (3D).

In one example, the XR cylinder 109 corresponds to head/display-locked content such that the XR cylinder 109 remains displayed at the same location on the display 122 as the FOV 111 changes due to translational and/or rotational movement of the electronic device 120. As another example, the XR cylinder 109 corresponds to world/object-locked content such that the XR cylinder 109 remains displayed at its origin location as the FOV 111 changes due to translational and/or rotational movement of the electronic device 120. As such, in this example, if the FOV 111 does not include the origin location, the displayed XR environment 128 will not include the XR cylinder 109. As another example, the XR cylinder 109 corresponds to body-locked content such that it remains at a positional and rotational offset from the body of the user 150. In some examples, the electronic device 120 corresponds to a near-eye system, mobile phone, tablet, laptop, wearable computing device, or the like.

In some implementations, the display 122 corresponds to an additive display that enables optical see-through of the physical environment 105 including the table 107 and the portrait 523. For example, the display 122 corresponds to a transparent lens, and the electronic device 120 corresponds to a pair of glasses worn by the user 150. As such, in some implementations, the electronic device 120 presents a user interface by projecting the XR content (e.g., the XR cylinder 109) onto the additive display, which is, in turn, overlaid on the physical environment 105 from the perspective of the user 150. In some implementations, the electronic device 120 presents the user interface by displaying the XR content (e.g., the XR cylinder 109) on the additive display, which is, in turn, overlaid on the physical environment 105 from the perspective of the user 150.

In some implementations, the user 150 wears the electronic device 120 such as a near-eye system. As such, the electronic device 120 includes one or more displays provided to display the XR content (e.g., a single display or one for each eye). For example, the electronic device 120 encloses the FOV of the user 150. In such implementations, the electronic device 120 presents the XR environment 128 by displaying data corresponding to the XR environment 128 on the one or more displays or by projecting data corresponding to the XR environment 128 onto the retinas of the user 150.

In some implementations, the electronic device 120 includes an integrated display (e.g., a built-in display) that displays the XR environment 128. In some implementations, the electronic device 120 includes a head-mountable enclosure. In various implementations, the head-mountable enclosure includes an attachment region to which another device with a display can be attached. For example, in some implementations, the electronic device 120 can be attached to the head-mountable enclosure. In various implementations, the head-mountable enclosure is shaped to form a receptacle for receiving another device that includes a display (e.g., the electronic device 120). For example, in some implementations, the electronic device 120 slides/snaps into or otherwise attaches to the head-mountable enclosure. In some implementations, the display of the device attached to the head-mountable enclosure presents (e.g., displays) the XR environment 128. In some implementations, the electronic device 120 is replaced with an XR chamber, enclosure, or room configured to present XR content in which the user 150 does not wear the electronic device 120.

In some implementations, the controller 110 and/or the electronic device 120 cause an XR representation of the user 150 to move within the XR environment 128 based on movement information (e.g., body pose data, eye tracking data, hand/limb/finger/extremity tracking data, etc.) from the electronic device 120 and/or optional remote input devices within the physical environment 105. In some implementations, the optional remote input devices correspond to fixed or movable sensory equipment within the physical environment 105 (e.g., image sensors, depth sensors, infrared (IR) sensors, event cameras, microphones, etc.). In some implementations, each of the remote input devices is configured to collect/capture input data and provide the input data to the controller 110 and/or the electronic device 120 while the user 150 is physically within the physical environment 105. In some implementations, the remote input devices include microphones, and the input data includes audio data associated with the user 150 (e.g., speech samples). In some implementations, the remote input devices include image sensors (e.g., cameras), and the input data includes images of the user 150. In some implementations, the input data characterizes body poses of the user 150 at different times. In some implementations, the input data characterizes head poses of the user 150 at different times. In some implementations, the input data characterizes hand tracking information associated with the hands of the user 150 at different times. In some implementations, the input data characterizes the velocity and/or acceleration of body parts of the user 150 such as his/her hands. In some implementations, the input data indicates joint positions and/or joint orientations of the user 150. In some implementations, the remote input devices include feedback devices such as speakers, lights, or the like.

FIG. 2 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some implementations, the one or more communication buses 204 include circuitry that interconnects and controls communications between system components. In some implementations, the one or more I/O devices 206 include at least one of a keyboard, a mouse, a touchpad, a touchscreen, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof described below with respect to FIG. 2.

An operating system 230 includes procedures for handling various basic system services and for performing hardware dependent tasks.

In some implementations, a data obtainer 242 is configured to obtain data (e.g., captured image frames of the physical environment 105, presentation data, input data, user interaction data, camera pose tracking information, eye tracking information, head/body pose tracking information, hand/limb/finger/extremity tracking information, sensor data, location data, etc.) from at least one of the I/O devices 206 of the controller 110, the I/O devices and sensors 306 of the electronic device 120, and the optional remote input devices. To that end, in various implementations, the data obtainer 242 includes instructions and/or logic therefor, and heuristics and metadata therefor.

In some implementations, a mapper and locator engine 244 is configured to map the physical environment 105 and to track the position/location of at least the electronic device 120 or the user 150 with respect to the physical environment 105. To that end, in various implementations, the mapper and locator engine 244 includes instructions and/or logic therefor, and heuristics and metadata therefor.

In some implementations, a data transmitter 246 is configured to transmit data (e.g., presentation data such as rendered image frames associated with the XR environment, location data, etc.) to at least the electronic device 120 and optionally one or more other devices. To that end, in various implementations, the data transmitter 246 includes instructions and/or logic therefor, and heuristics and metadata therefor.

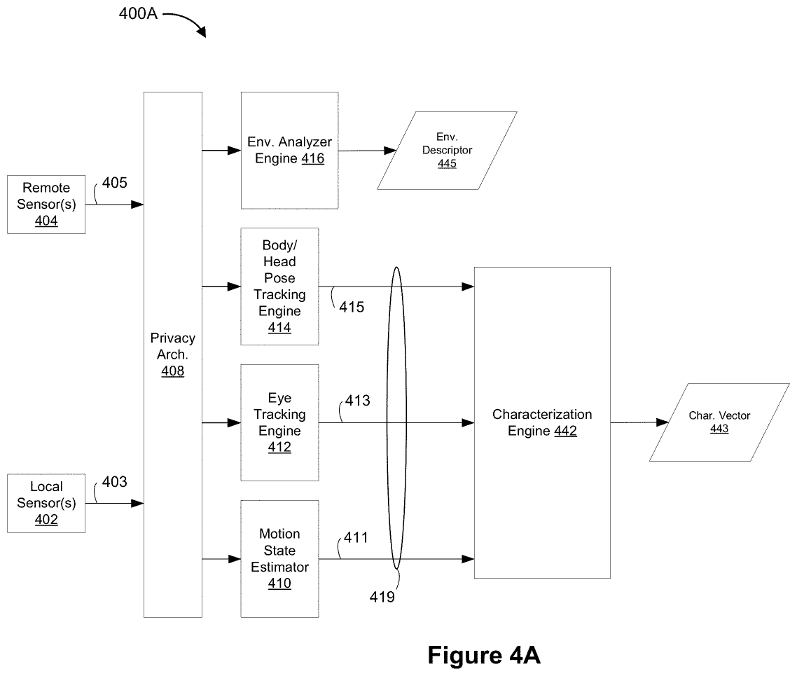

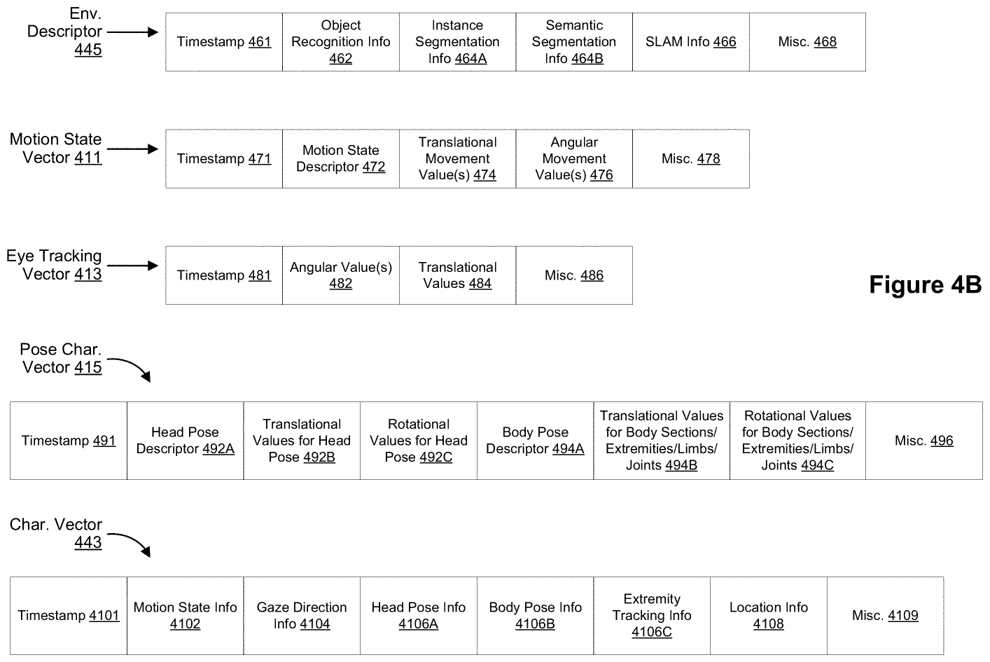

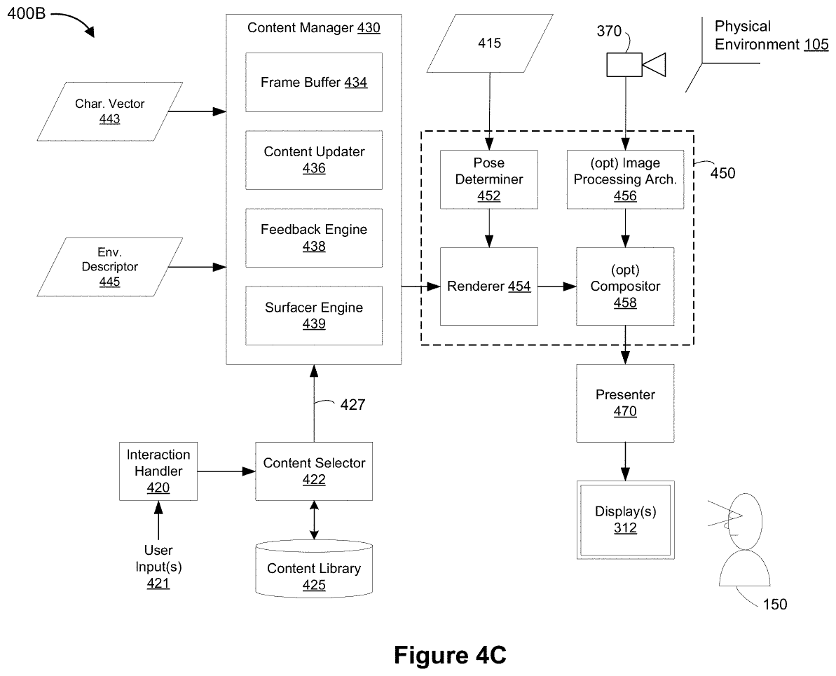

In some implementations, a privacy architecture 408 is configured to ingest data and filter user information and/or identifying information within the data based on one or more privacy filters. The privacy architecture 408 is described in more detail below with reference to FIG. 4A. To that end, in various implementations, the privacy architecture 408 includes instructions and/or logic therefor, and heuristics and metadata therefor.

In some implementations, a motion state estimator 410 is configured to obtain (e.g., receive, retrieve, or determine/generate) a motion state vector 411 associated with the electronic device 120 (and the user 150) (e.g., including a current motion state associated with the electronic device 120) based on input data and update the motion state vector 411 over time. For example, as shown in FIG. 4B, the motion state vector 411 includes a motion state descriptor 472 for the electronic device 120 (e.g., stationary, in-motion, walking, running, cycling, operating or riding in an automobile car, operating or riding in a boat, operating or riding in a bus, operating or riding in a train, operating or riding in an aircraft, or the like), translational movement values 474 associated with the electronic device 120 (e.g., a heading, a velocity value, an acceleration value, etc.), angular movement values 476 associated with the electronic device 120 (e.g., an angular velocity value, an angular acceleration value, and/or the like for each of the pitch, roll, and yaw dimensions), and/or the like. The motion state estimator 410 is described in more detail below with reference to FIG. 4A. To that end, in various implementations, the motion state estimator 410 includes instructions and/or logic therefor, and heuristics and metadata therefor.

In some implementations, an eye tracking engine 412 is configured to obtain (e.g., receive, retrieve, or determine/generate) an eye tracking vector 413 as shown in FIG. 4B (e.g., with a gaze direction) based on the input data and update the eye tracking vector 413 over time. For example, the gaze direction indicates a point (e.g., associated with x, y, and z coordinates relative to the physical environment 105 or the world-at-large), a physical object, or a region of interest (ROI) in the physical environment 105 at which the user 150 is currently looking. As another example, the gaze direction indicates a point (e.g., associated with x, y, and z coordinates relative to the XR environment 128), an XR object, or a ROI in the XR environment 128 at which the user 150 is currently looking. The eye tracking engine 412 is described in more detail below with reference to FIG. 4A. To that end, in various implementations, the eye tracking engine 412 includes instructions and/or logic therefor, and heuristics and metadata therefor.

In some implementations, a body/head pose tracking engine 414 is configured to obtain (e.g., receive, retrieve, or determine/generate) a pose characterization vector 415 based on the input data and update the pose characterization vector 415 over time. For example, as shown in FIG. 4B, the pose characterization vector 415 includes a head pose descriptor 492A (e.g., upward, downward, neutral, etc.), translational values 492B for the head pose, rotational values 492C for the head pose, a body pose descriptor 494A (e.g., standing, sitting, prone, etc.), translational values 494B for body sections/extremities/limbs/joints, rotational values 494C for the body sections/extremities/limbs/joints, and/or the like. The body/head pose tracking engine 414 is described in more detail below with reference to FIG. 4A. To that end, in various implementations, the body/head pose tracking engine 414 includes instructions and/or logic therefor, and heuristics and metadata therefor. In some implementations, the motion state estimator 410, the eye tracking engine 412, and the body/head pose tracking engine 414 may be located on the electronic device 120 in addition to or in place of the controller 110.

In some implementations, an environment analyzer engine 416 is configured to obtain (e.g., receive, retrieve, or determine/generate) an environment descriptor 445 based on the input data and update the environment descriptor 445 over time. For example, as shown in FIG. 4B, the environment descriptor 445 includes object recognition information 462, instance segmentation information 464A, semantic segmentation information 464B, simultaneous localization and mapping (SLAM) information 466, and/or the like. The environment analyzer engine 416 is described in more detail below with reference to FIG. 4A. To that end, in various implementations, the environment analyzer engine 416 includes instructions and/or logic therefor, and heuristics and metadata therefor.

In some implementations, a content selector 422 is configured to select XR content (sometimes also referred to herein as “graphical content” or “virtual content”) from a content library 425 based on one or more user requests and/or inputs (e.g., a voice command, a selection from a user interface (UI) menu of XR content items or virtual agents (VAs), and/or the like). The content selector 422 is described in more detail below with reference to FIG. 4A. To that end, in various implementations, the content selector 422 includes instructions and/or logic therefor, and heuristics and metadata therefor.

In some implementations, a content library 425 includes a plurality of content items such as audio/visual (A/V) content, virtual agents (VAs), and/or XR content, objects, items, scenery, etc. As one example, the XR content includes 3D reconstructions of user captured videos, movies, TV episodes, and/or other XR content. In some implementations, the content library 425 is pre-populated or manually authored by the user 150. In some implementations, the content library 425 is located local relative to the controller 110. In some implementations, the content library 425 is located remote from the controller 110 (e.g., at a remote server, a cloud server, or the like).

In some implementations, a characterization engine 442 is configured to determine/generate a characterization vector 443 based on at least one of the motion state vector 411, the eye tracking vector 413, and the pose characterization vector 415 as shown in FIG. 4A. In some implementations, the characterization engine 442 is also configured to update the pose characterization vector 443 over time. As shown in FIG. 4B, the characterization vector 443 includes motion state information 4102, gaze direction information 4104, head pose information 4106A, body pose information 4106B, extremity tracking information 4106C, location information 4108, and/or the like. The characterization engine 442 is described in more detail below with reference to FIG. 4A. To that end, in various implementations, the characterization engine 442 includes instructions and/or logic therefor, and heuristics and metadata therefor.

In some implementations, a content manager 430 is configured to manage and update the layout, setup, structure, and/or the like for the XR environment 128 including one or more of VA(s), XR content, one or more user interface (UI) elements associated with the XR content, and/or the like. The content manager 430 is described in more detail below with reference to FIG. 4C. To that end, in various implementations, the content manager 430 includes instructions and/or logic therefor, and heuristics and metadata therefor. In some implementations, the content manager 430 includes a frame buffer 434, a content updater 436, a feedback engine 438, and a surfacer engine 439. In some implementations, the frame buffer 434 includes XR content, a rendered image frame, and/or the like for one or more past instances and/or frames.

In some implementations, the content updater 436 is configured to modify the XR environment 128 over time based on translational or rotational movement of the electronic device 120 or physical objects within the physical environment 105, user inputs (e.g., a change in context, hand/extremity tracking inputs, eye tracking inputs or gaze inputs, touch inputs, gesture inputs, voice inputs/commands, modification/manipulation inputs with the physical object, and/or the like), and/or the like. To that end, in various implementations, the content updater 436 includes instructions and/or logic therefor, and heuristics and metadata therefor.

In some implementations, the feedback engine 438 is configured to generate sensory feedback (e.g., visual feedback such as text or lighting changes, audio feedback, haptic feedback, etc.) associated with the XR environment 128. To that end, in various implementations, the feedback engine 438 includes instructions and/or logic therefor, and heuristics and metadata therefor.

In some implementations, in response to obtaining (e.g., receiving, retrieving, or the like) an electronic message (e.g., an SMS, MMS, email, chat, etc.), the surfacer engine 439 is configured to determine whether the electronic message includes an attachment flag or metadata indicating that the electronic message is attached to or associated with a particular real-world object. In some implementations, in response to determining that the electronic message is attached to or associated with the real-world object, the surfacer engine 439 is further configured to determine whether a current FOV of the physical environment 105 includes the real-world object. In some implementations, the surfacer engine 439 is further configured to cause the rendering engine 450 to surface or present an XR object within the XR environment 128 that corresponds to the electronic message in association with the real-world object (e.g., a physical object) in accordance with a determination that the current FOV of the physical environment 105 includes the real-world object. To that end, in various implementations, the surfacer engine 439 includes instructions and/or logic therefor, and heuristics and metadata therefor.

In some implementations, a rendering engine 450 is configured to render a user interface (UI), an XR environment 128 (sometimes also referred to herein as a “graphical environment” or “virtual environment”), or image frame(s) associated therewith including UI elements, VA(s), XR content, one or more UI elements associated with the XR content, and/or the like. To that end, in various implementations, the rendering engine 450 includes instructions and/or logic therefor, and heuristics and metadata therefor. In some implementations, the rendering engine 450 includes a pose determiner 452, a renderer 454, an optional image processing architecture 456, and an optional compositor 458. One of ordinary skill in the art will appreciate that the optional image processing architecture 456 and the optional compositor 458 may be present for video pass-through configurations but may be removed for fully VR or optical see-through configurations.

In some implementations, the pose determiner 452 is configured to determine a current camera pose of the electronic device 120 and/or the user 150 relative to the A/V content and/or XR content. The pose determiner 452 is described in more detail below with reference to FIG. 4A. To that end, in various implementations, the pose determiner 452 includes instructions and/or logic therefor, and heuristics and metadata therefor.

In some implementations, the renderer 454 is configured to render the A/V content and/or the XR content according to the current camera pose relative thereto. The renderer 454 is described in more detail below with reference to FIG. 4A. To that end, in various implementations, the renderer 454 includes instructions and/or logic therefor, and heuristics and metadata therefor.

In some implementations, the image processing architecture 456 is configured to obtain (e.g., receive, retrieve, or capture) an image stream including one or more images of the physical environment 105 from the current camera pose of the electronic device 120 and/or the user 150. In some implementations, the image processing architecture 456 is also configured to perform one or more image processing operations on the image stream such as warping, color correction, gamma correction, sharpening, noise reduction, white balance, and/or the like. The image processing architecture 456 is described in more detail below with reference to FIG. 4A. To that end, in various implementations, the image processing architecture 456 includes instructions and/or logic therefor, and heuristics and metadata therefor.

In some implementations, the compositor 458 is configured to composite the rendered A/V content and/or XR content with the processed image stream of the physical environment 105 from the image processing architecture 456 to produce rendered image frames of the XR environment 128 for display. The compositor 458 is described in more detail below with reference to FIG. 4A. To that end, in various implementations, the compositor 458 includes instructions and/or logic therefor, and heuristics and metadata therefor.

Although the data obtainer 242, the mapper and locator engine 244, the data transmitter 246, the privacy architecture 408, the motion state estimator 410, the eye tracking engine 412, the body/head pose tracking engine 414, the content selector 422, the content manager 430, the operation modality manager 440, and the rendering engine 450 are shown as residing on a single device (e.g., the controller 110), it should be understood that in other implementations, any combination of the data obtainer 242, the mapper and locator engine 244, the data transmitter 246, the privacy architecture 408, the motion state estimator 410, the eye tracking engine 412, the body/head pose tracking engine 414, the content selector 422, the content manager 430, the operation modality manager 440, and the rendering engine 450 may be located in separate computing devices.

In some implementations, the functions and/or components of the controller 110 are combined with or provided by the electronic device 120 shown below in FIG. 3. Moreover, FIG. 2 is intended more as a functional description of the various features which may be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 3 is a block diagram of an example of the electronic device 120 (e.g., a mobile phone, tablet, laptop, near-eye system, wearable computing device, or the like) in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations, the electronic device 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more displays 312, an image capture device 370 (e.g., one or more optional interior- and/or exterior-facing image sensors), a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a magnetometer, a thermometer, one or more physiological sensors (e.g., blood pressure monitor, heart rate monitor, blood oximetry monitor, blood glucose monitor, etc.), one or more microphones, one or more speakers, a haptics engine, a heating and/or cooling unit, a skin shear engine, one or more depth sensors (e.g., structured light, time-of-flight, LiDAR, or the like), a localization and mapping engine, an eye tracking engine, a body/head pose tracking engine, a hand/limb/finger/extremity tracking engine, a camera pose tracking engine, and/or the like.

In some implementations, the one or more displays 312 are configured to present the XR environment to the user. In some implementations, the one or more displays 312 are also configured to present flat video content to the user (e.g., a 2-dimensional or “flat” AVI, FLV, WMV, MOV, MP4, or the like file associated with a TV episode or a movie, or live video pass-through of the physical environment 105). In some implementations, the one or more displays 312 correspond to touchscreen displays. In some implementations, the one or more displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more displays 312 correspond to diffractive, reflective, polarized, holographic, etc. waveguide displays. For example, the electronic device 120 includes a single display. In another example, the electronic device 120 includes a display for each eye of the user. In some implementations, the one or more displays 312 are capable of presenting AR and VR content. In some implementations, the one or more displays 312 are capable of presenting AR or VR content.

In some implementations, the image capture device 370 correspond to one or more RGB cameras (e.g., with a complementary metal-oxide-semiconductor (CMOS) image sensor or a charge-coupled device (CCD) image sensor), IR image sensors, event-based cameras, and/or the like. In some implementations, the image capture device 370 includes a lens assembly, a photodiode, and a front-end architecture. In some implementations, the image capture device 370 includes exterior-facing and/or interior-facing image sensors.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and a presentation engine 340.

The operating system 330 includes procedures for handling various basic system services and for performing hardware dependent tasks. In some implementations, the presentation engine 340 is configured to present media items and/or XR content to the user via the one or more displays 312. To that end, in various implementations, the presentation engine 340 includes a data obtainer 342, an interaction handler 420, a presenter 470, and a data transmitter 350.

In some implementations, the data obtainer 342 is configured to obtain data (e.g., presentation data such as rendered image frames associated with the user interface or the XR environment, input data, user interaction data, head tracking information, camera pose tracking information, eye tracking information, hand/limb/finger/extremity tracking information, sensor data, location data, etc.) from at least one of the I/O devices and sensors 306 of the electronic device 120, the controller 110, and the remote input devices. To that end, in various implementations, the data obtainer 342 includes instructions and/or logic therefor, and heuristics and metadata therefor.

In some implementations, the interaction handler 420 is configured to detect user interactions (e.g., gestural inputs detected via hand/extremity tracking, eye gaze inputs detected via eye tracking, voice commands, etc.) with the presented A/V content and/or XR content. To that end, in various implementations, the interaction handler 420 includes instructions and/or logic therefor, and heuristics and metadata therefor.

In some implementations, the presenter 470 is configured to present and update A/V content and/or XR content (e.g., the rendered image frames associated with the user interface or the XR environment 128 including the VA(s), the XR content, one or more UI elements associated with the XR content, and/or the like) via the one or more displays 312. To that end, in various implementations, the presenter 470 includes instructions and/or logic therefor, and heuristics and metadata therefor.

In some implementations, the data transmitter 350 is configured to transmit data (e.g., presentation data, location data, user interaction data, head tracking information, camera pose tracking information, eye tracking information, hand/limb/finger/extremity tracking information, etc.) to at least the controller 110. To that end, in various implementations, the data transmitter 350 includes instructions and/or logic therefor, and heuristics and metadata therefor.

Although the data obtainer 342, the interaction handler 420, the presenter 470, and the data transmitter 350 are shown as residing on a single device (e.g., the electronic device 120), it should be understood that in other implementations, any combination of the data obtainer 342, the interaction handler 420, the presenter 470, and the data transmitter 350 may be located in separate computing devices.

Moreover, FIG. 3 is intended more as a functional description of the various features which may be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 4A is a block diagram of a first portion 400A of an example content delivery architecture in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the content delivery architecture is included in a computing system such as the controller 110 shown in FIGS. 1 and 2; the electronic device 120 shown in FIGS. 1 and 3; and/or a suitable combination thereof.

As shown in FIG. 4A, one or more local sensors 402 of the controller 110, the electronic device 120, and/or a combination thereof obtain local sensor data 403 associated with the physical environment 105. For example, the local sensor data 403 includes images or a stream thereof of the physical environment 105, simultaneous location and mapping (SLAM) information for the physical environment 105 and the location of the electronic device 120 or the user 150 relative to the physical environment 105, ambient lighting information for the physical environment 105, ambient audio information for the physical environment 105, acoustic information for the physical environment 105, dimensional information for the physical environment 105, semantic labels for objects within the physical environment 105, and/or the like. In some implementations, the local sensor data 403 includes un-processed or post-processed information.

Similarly, as shown in FIG. 4A, one or more remote sensors 404 associated with the optional remote input devices within the physical environment 105 obtain remote sensor data 405 associated with the physical environment 105. For example, the remote sensor data 405 includes images or a stream thereof of the physical environment 105, SLAM information for the physical environment 105 and the location of the electronic device 120 or the user 150 relative to the physical environment 105, ambient lighting information for the physical environment 105, ambient audio information for the physical environment 105, acoustic information for the physical environment 105, dimensional information for the physical environment 105, semantic labels for objects within the physical environment 105, and/or the like. In some implementations, the remote sensor data 405 includes un-processed or post-processed information.

According to some implementations, the privacy architecture 408 ingests the local sensor data 403 and the remote sensor data 405. In some implementations, the privacy architecture 408 includes one or more privacy filters associated with user information and/or identifying information. In some implementations, the privacy architecture 408 includes an opt-in feature where the electronic device 120 informs the user 150 as to what user information and/or identifying information is being monitored and how the user information and/or the identifying information will be used. In some implementations, the privacy architecture 408 selectively prevents and/or limits the content delivery architecture 400A/400B or portions thereof from obtaining and/or transmitting the user information. To this end, the privacy architecture 408 receives user preferences and/or selections from the user 150 in response to prompting the user 150 for the same. In some implementations, the privacy architecture 408 prevents the content delivery architecture 400A/400B from obtaining and/or transmitting the user information unless and until the privacy architecture 408 obtains informed consent from the user 150. In some implementations, the privacy architecture 408 anonymizes (e.g., scrambles, obscures, encrypts, and/or the like) certain types of user information. For example, the privacy architecture 408 receives user inputs designating which types of user information the privacy architecture 408 anonymizes. As another example, the privacy architecture 408 anonymizes certain types of user information likely to include sensitive and/or identifying information, independent of user designation (e.g., automatically).

According to some implementations, the motion state estimator 410 obtains the local sensor data 403 and the remote sensor data 405 after it has been subjected to the privacy architecture 408. In some implementations, the motion state estimator 410 obtains (e.g., receives, retrieves, or determines/generates) a motion state vector 411 based on the input data and updates the motion state vector 411 over time.

FIG. 4B shows an example data structure for the motion state vector 411 in accordance with some implementations. As shown in FIG. 4B, the motion state vector 411 may correspond to an N-tuple characterization vector or characterization tensor that includes a timestamp 471 (e.g., the most recent time the motion state vector 411 was updated), a motion state descriptor 472 for the electronic device 120 (e.g., stationary, in-motion, car, boat, bus, train, plane, or the like), translational movement values 474 associated with the electronic device 120 (e.g., a heading, a displacement value, a velocity value, an acceleration value, a jerk value, etc.), angular movement values 476 associated with the electronic device 120 (e.g., an angular displacement value, an angular velocity value, an angular acceleration value, an angular jerk value, and/or the like for each of the pitch, roll, and yaw dimensions), and/or miscellaneous information 478. One of ordinary skill in the art will appreciate that the data structure for the motion state vector 411 in FIG. 4B is merely an example that may include different information portions in various other implementations and be structured in myriad ways in various other implementations.

According to some implementations, the eye tracking engine 412 obtains the local sensor data 403 and the remote sensor data 405 after it has been subjected to the privacy architecture 408. In some implementations, the eye tracking engine 412 obtains (e.g., receives, retrieves, or determines/generates) an eye tracking vector 413 based on the input data and updates the eye tracking vector 413 over time.

FIG. 4B shows an example data structure for the eye tracking vector 413 in accordance with some implementations. As shown in FIG. 4B, the eye tracking vector 413 may correspond to an N-tuple characterization vector or characterization tensor that includes a timestamp 481 (e.g., the most recent time the eye tracking vector 413 was updated), one or more angular values 482 for a current gaze direction (e.g., roll, pitch, and yaw values), one or more translational values 484 for the current gaze direction (e.g., x, y, and z values relative to the physical environment 105, the world-at-large, and/or the like), and/or miscellaneous information 486. One of ordinary skill in the art will appreciate that the data structure for the eye tracking vector 413 in FIG. 4B is merely an example that may include different information portions in various other implementations and be structured in myriad ways in various other implementations.

For example, the gaze direction indicates a point (e.g., associated with x, y, and z coordinates relative to the physical environment 105 or the world-at-large), a physical object, or a region of interest (ROI) in the physical environment 105 at which the user 150 is currently looking. As another example, the gaze direction indicates a point (e.g., associated with x, y, and z coordinates relative to the XR environment 128), an XR object, or a region of interest (ROI) in the XR environment 128 at which the user 150 is currently looking.

According to some implementations, the body/head pose tracking engine 414 obtains the local sensor data 403 and the remote sensor data 405 after it has been subjected to the privacy architecture 408. In some implementations, the body/head pose tracking engine 414 obtains (e.g., receives, retrieves, or determines/generates) a pose characterization vector 415 based on the input data and updates the pose characterization vector 415 over time.

FIG. 4B shows an example data structure for the pose characterization vector 415 in accordance with some implementations. As shown in FIG. 4B, the pose characterization vector 415 may correspond to an N-tuple characterization vector or characterization tensor that includes a timestamp 491 (e.g., the most recent time the pose characterization vector 415 was updated), a head pose descriptor 492A (e.g., upward, downward, neutral, etc.), translational values for the head pose 492B, rotational values for the head pose 492C, a body pose descriptor 494A (e.g., standing, sitting, prone, etc.), translational values for body sections/extremities/limbs/joints 494B, rotational values for the body sections/extremities/limbs/joints 494C, and/or miscellaneous information 496. In some implementations, the pose characterization vector 415 also includes information associated with finger/hand/extremity tracking. One of ordinary skill in the art will appreciate that the data structure for the pose characterization vector 415 in FIG. 4B is merely an example that may include different information portions in various other implementations and be structured in myriad ways in various other implementations. According to some implementations, the motion state vector 411, the eye tracking vector 413 and the pose characterization vector 415 are collectively referred to as an input vector 419.

According to some implementations, the characterization engine 442 obtains the motion state vector 411, the eye tracking vector 413 and the pose characterization vector 415. In some implementations, the characterization engine 442 obtains (e.g., receives, retrieves, or determines/generates) the characterization vector 443 based on the motion state vector 411, the eye tracking vector 413, and the pose characterization vector 415.

FIG. 4B shows an example data structure for the characterization vector 443 in accordance with some implementations. As shown in FIG. 4B, the characterization vector 443 may correspond to an N-tuple characterization vector or characterization tensor that includes a timestamp 4101 (e.g., the most recent time the characterization vector 443 was updated), motion state information 4102 (e.g., the motion state descriptor 472), gaze direction information 4104 (e.g., a function of the one or more angular values 482 and the one or more translational values 484 within the eye tracking vector 413), head pose information 4106A (e.g., the head pose descriptor 492A), body pose information 4106B (e.g., a function of the body pose descriptor 494A within the pose characterization vector 415), extremity tracking information 4106C (e.g., a function of the body pose descriptor 494A within the pose characterization vector 415 that is associated with extremities of the user 150 that are being tracked by the controller 110, the electronic device 120, and/or a combination thereof), location information 4108 (e.g., a household location such as a kitchen or living room, a vehicular location such as an automobile, plane, etc., and/or the like), and/or miscellaneous information 4109.

According to some implementations, the environment analyzer engine 416 obtains the local sensor data 403 and the remote sensor data 405 after it has been subjected to the privacy architecture 408. In some implementations, the environment analyzer engine 416 obtains (e.g., receives, retrieves, or determines/generates) an environment descriptor 445 based on the input data (e.g., the local sensor data 403 and the remote sensor data 405) and updates the environment descriptor 445 over time.

FIG. 4B shows an example data structure for the environment descriptor 445 in accordance with some implementations. As shown in FIG. 4B, the environment descriptor 445 may correspond to an N-tuple characterization vector or characterization tensor that includes a timestamp 461 (e.g., the most recent time the environment descriptor 445 was updated), object recognition information 462 associated with physical objects recognized within the physical environment 105 (e.g., based on a classification algorithm, computer vision (CV) techniques, or the like), instance segmentation information 464A associated with the physical environment 105, semantic segmentation information 464B such as labels for physical objects within the physical environment 105, SLAM information 466 associated with the physical environment 105 (e.g., a map, a mesh, a point cloud, or the like for the physical environment 105 as well as the current location of the electronic device 120 therewithin), and/or miscellaneous information 468. One of ordinary skill in the art will appreciate that the data structure for the environment descriptor 445 in FIG. 4B is merely an example that may include different information portions in various other implementations and be structured in myriad ways in various other implementations.

FIG. 4C is a block diagram of a second portion 400B of the example content delivery architecture in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the content delivery architecture is included in a computing system such as the controller 110 shown in FIGS. 1 and 2; the electronic device 120 shown in FIGS. 1 and 3; and/or a suitable combination thereof. FIG. 4C is similar to and adapted from FIG. 4A. Therefore, similar reference numbers are used in FIGS. 4A and 4C. As such, only the differences between FIGS. 4A and 4C will be described below for the sake of brevity.

According to some implementations, the interaction handler 420 obtains (e.g., receives, retrieves, or detects) one or more user inputs 421 provided by the user 150 that are associated with selecting A/V content, one or more VAs, and/or XR content for presentation. For example, the one or more user inputs 421 correspond to a gestural input selecting XR content from a UI menu detected via hand/extremity tracking, an eye gaze input selecting XR content from the UI menu detected via eye tracking, a voice command selecting XR content from the UI menu detected via a microphone, and/or the like. In some implementations, the content selector 422 selects XR content 427 from the content library 425 based on one or more user inputs 421 (e.g., a voice command, a selection from a menu of XR content items, and/or the like).

In various implementations, the content manager 430 manages and updates the layout, setup, structure, and/or the like for the UI, the XR environment 128, or the image frame(s) associated therewith, including one or more of UI elements, VAs, XR content, one or more UI elements associated with the XR content, and/or the like, based on the characterization vector 443, the environment descriptor 445, (optionally) the user inputs 421, and/or the like. To that end, the content manager 430 includes the frame buffer 434, the content updater 436, the feedback engine 438, and the surfacer engine 439.

In some implementations, the frame buffer 434 includes XR content, a rendered image frame, and/or the like for one or more past instances and/or frames. In some implementations, the content updater 436 modifies the UI or the XR environment 128 over time based on the characterization vector 443, the environment descriptor 445, the user inputs 421 associated with modifying and/or manipulating the XR content or VA(s), translational or rotational movement of objects within the physical environment 105, translational or rotational movement of the electronic device 120 (or the user 150), and/or the like. In some implementations, the feedback engine 438 generates sensory feedback (e.g., visual feedback such as text or lighting changes, audio feedback, haptic feedback, etc.) associated with the XR environment 128.

In some implementations, in response to obtaining an electronic message, the surfacer engine 439 determines whether the electronic message includes an attachment flag or metadata indicating that the electronic message is attached to or associated with a particular real-world object. For example, the surfacer engine 439 makes the aforementioned determination by analyzing or parsing the content, context, etc. of the electronic message. In some implementations, in response to determining that the electronic message is attached to or associated with the real-world object, the surfacer engine 439 determines whether a current FOV of the physical environment 105 includes the real-world object. In some implementations, the surfacer engine 439 causes the rendering engine 450 to surface or present an XR object within the XR environment 128 that corresponds to the electronic message in association with the real-world object (e.g., a physical object) in accordance with a determination that the current FOV of the physical environment 105 includes the real-world object.

According to some implementations, the pose determiner 452 determines a current camera pose of the electronic device 120 and/or the user 150 relative to the XR environment 128 and/or the physical environment 105 based at least in part on the pose characterization vector 415. In some implementations, the renderer 454 renders the VA(s), the XR content 427, one or more UI elements associated with the XR content, and/or the like according to the current camera pose relative thereto.

According to some implementations, the optional image processing architecture 456 obtains an image stream from an image capture device 370 including one or more images of the physical environment 105 from the current camera pose of the electronic device 120 and/or the user 150. In some implementations, the image processing architecture 456 also performs one or more image processing operations on the image stream such as warping, color correction, gamma correction, sharpening, noise reduction, white balance, and/or the like. In some implementations, the optional compositor 458 composites the rendered XR content with the processed image stream of the physical environment 105 from the image processing architecture 456 to produce rendered image frames of the XR environment 128. In various implementations, the presenter 470 presents the rendered image frames of the XR environment 128 to the user 150 via the one or more displays 312. One of ordinary skill in the art will appreciate that the optional image processing architecture 456 and the optional compositor 458 may not be applicable for fully virtual environments (or optical see-through scenarios).

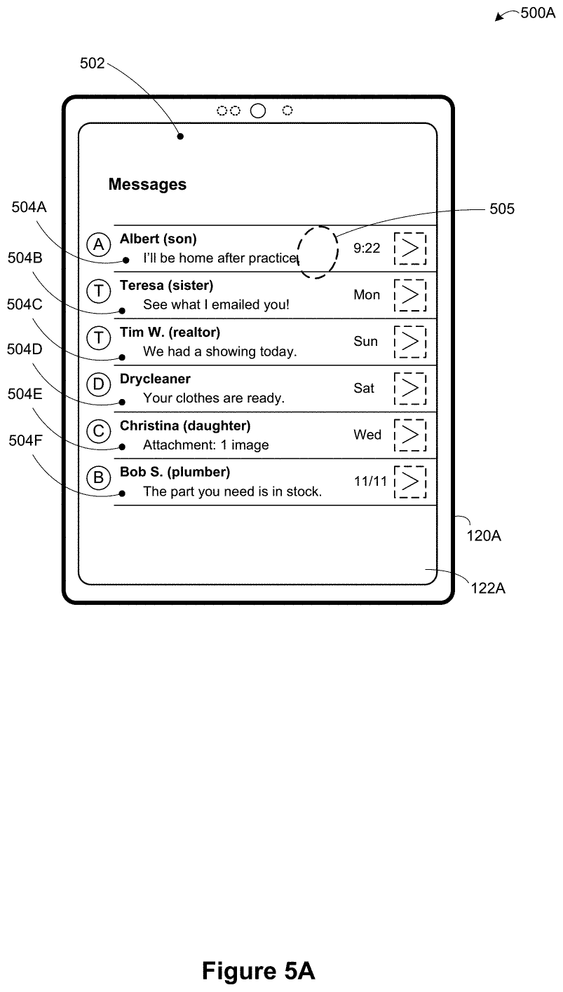

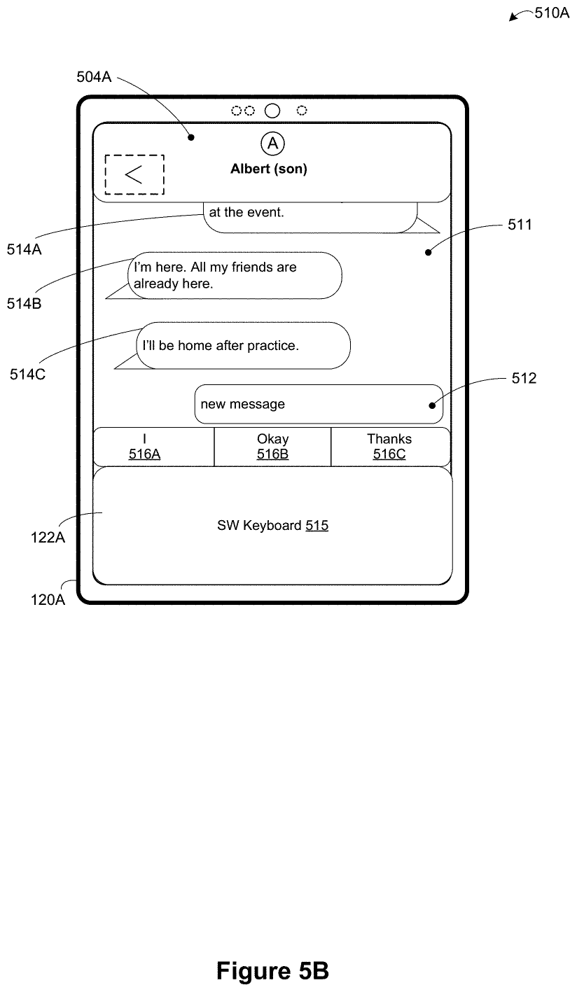

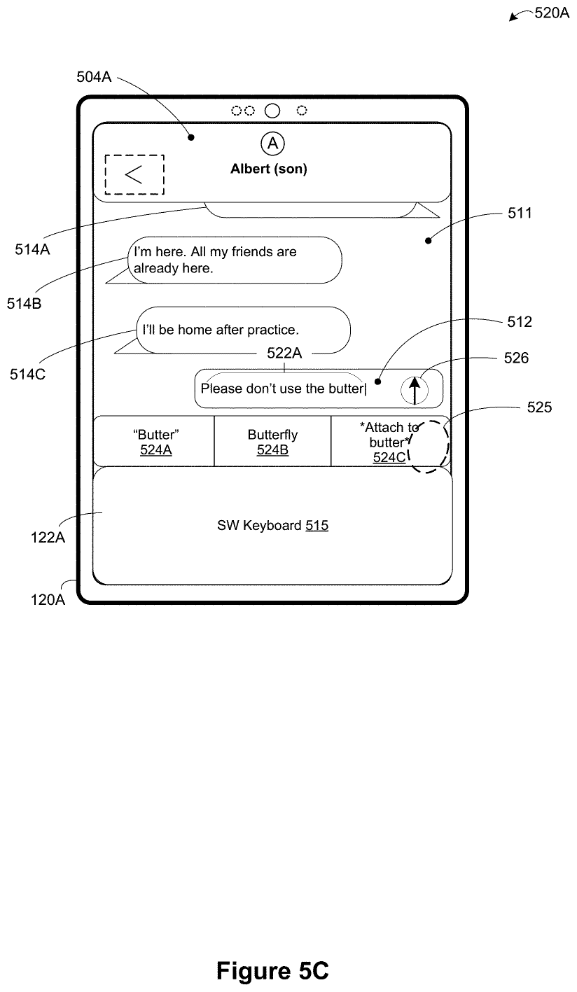

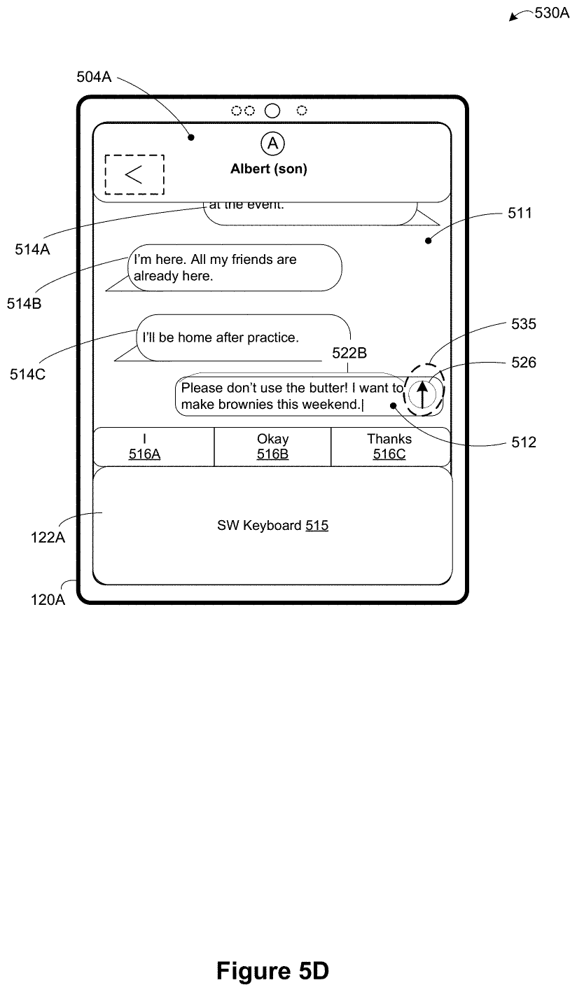

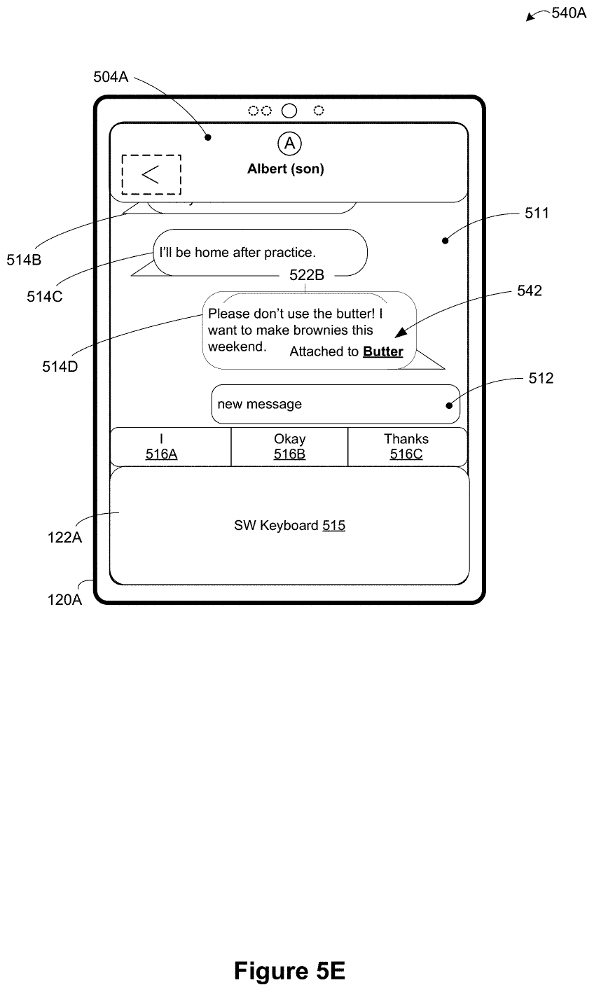

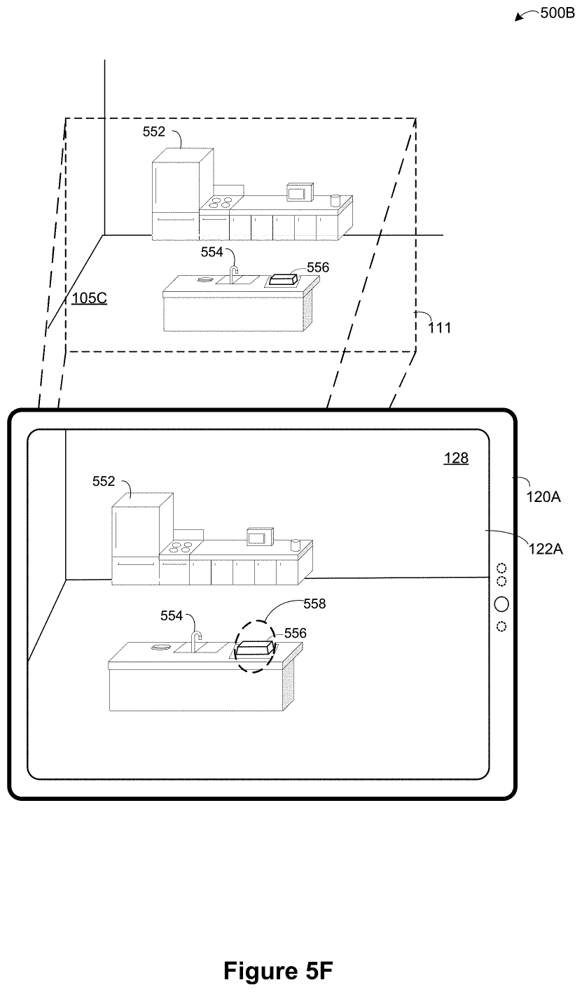

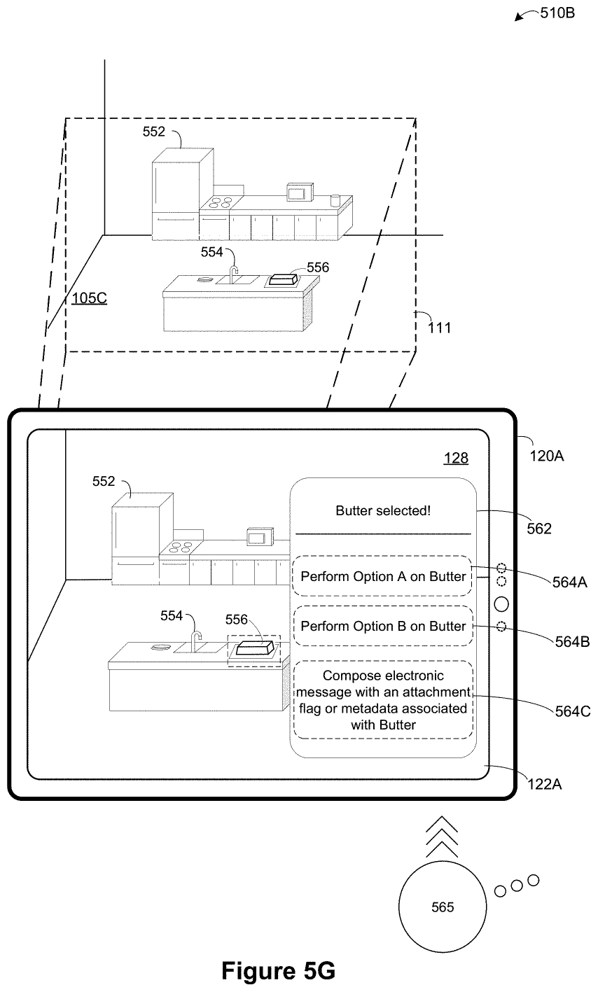

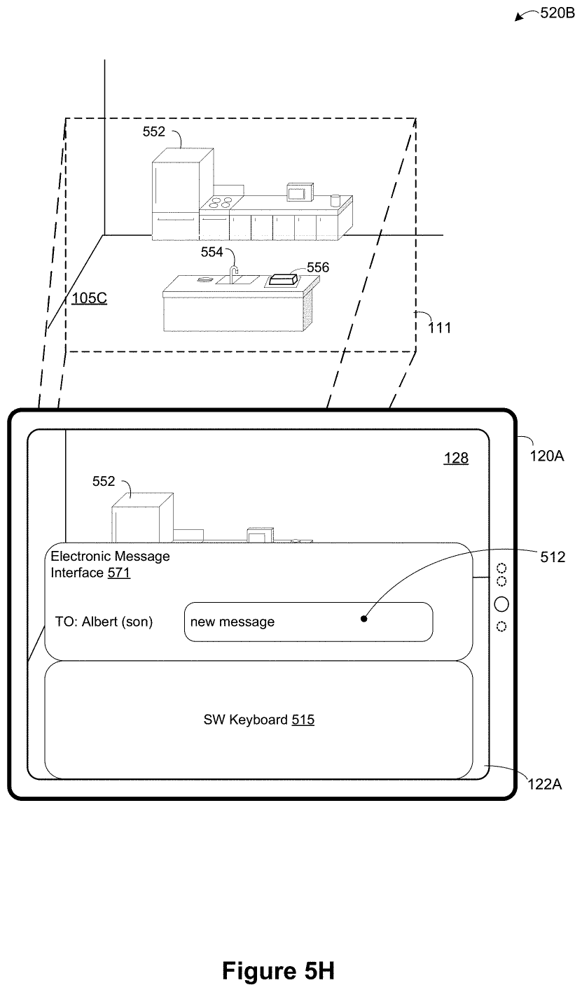

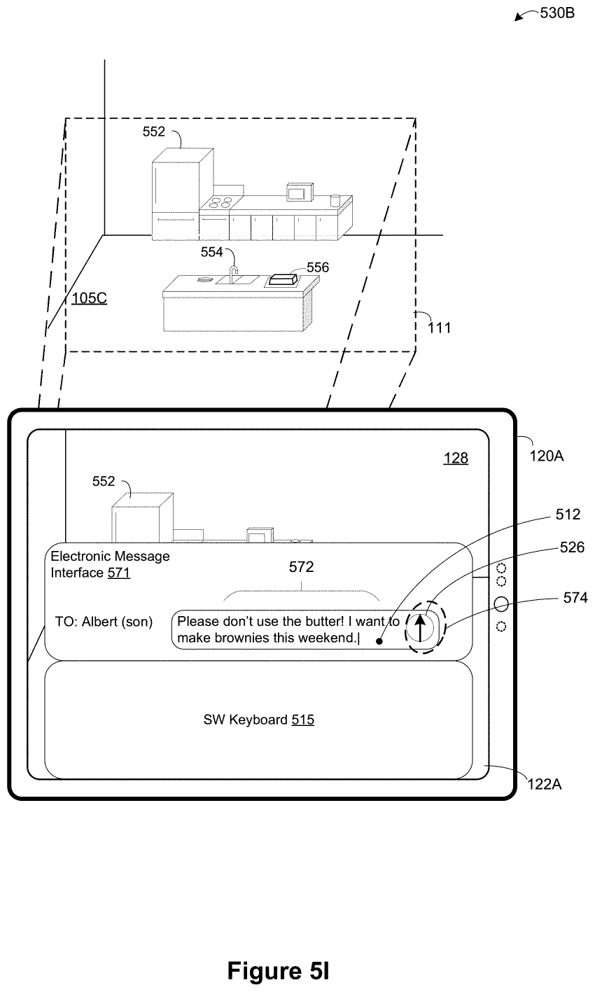

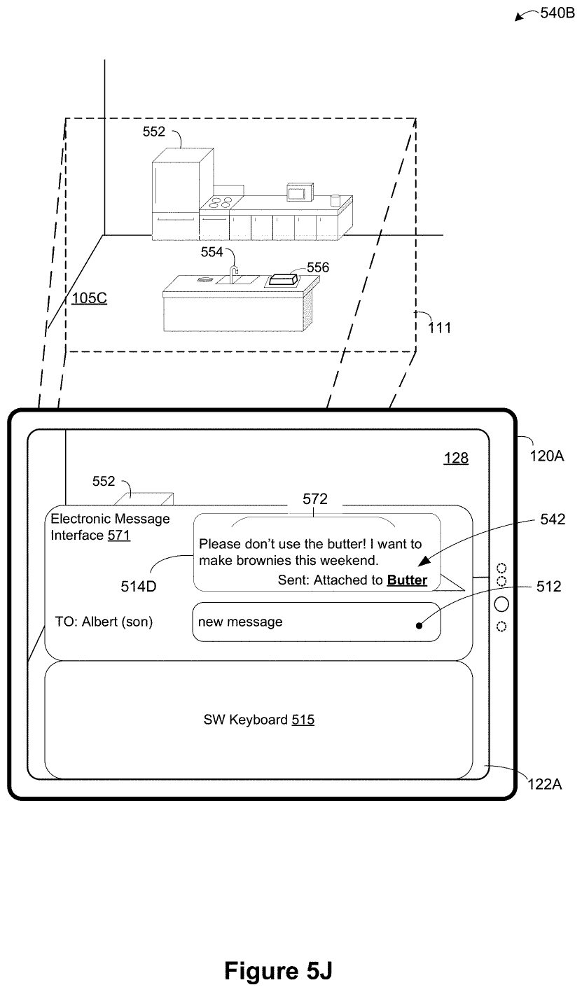

FIGS. 5A-5E illustrate a first sequence of instances 500A-540A associated with sending an electronic message associated with a real-world object in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, the sequence of instances 500A-540A are rendered and presented by a first electronic device 120A associated with a first user (e.g., the sender) that includes a display 122A. For example, the first electronic device 120A is similar to and adapted from the electronic device 120 described with reference to FIGS. 1 and 3. As such, similar reference numbers are used between FIGS. 1, 3, and 5A-5E and only the differences therebetween will be discussed for the sake of brevity.

As shown in FIG. 5A, during the instance 500A (e.g., associated with time T0), the first electronic device 120A presents, via the display 122A, an electronic message management interface 502 including a plurality of electronic message threads 504A-504F associated with ongoing conversations between the first user of the first electronic device 120A and one or more other users. Furthermore, as shown in FIG. 5A, the first electronic device 120A detects a selection input 505, such as a gaze input, voice input, gesture input, touch input (e.g., a finger contact, a tap gesture, etc. detected via a touch-sensitive surface (TSS) integrated with the display 122A), or the like, directed to an electronic message thread 504A.

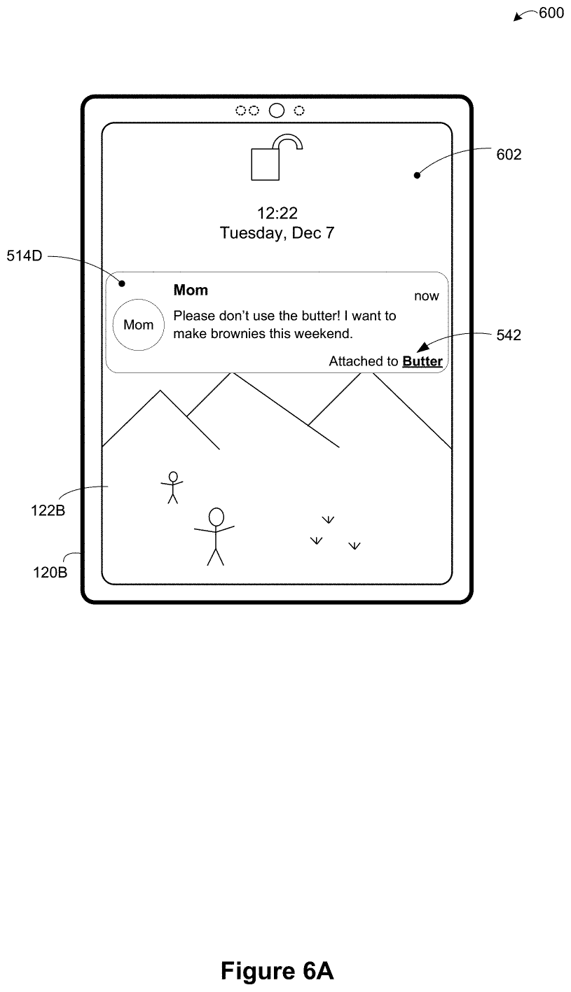

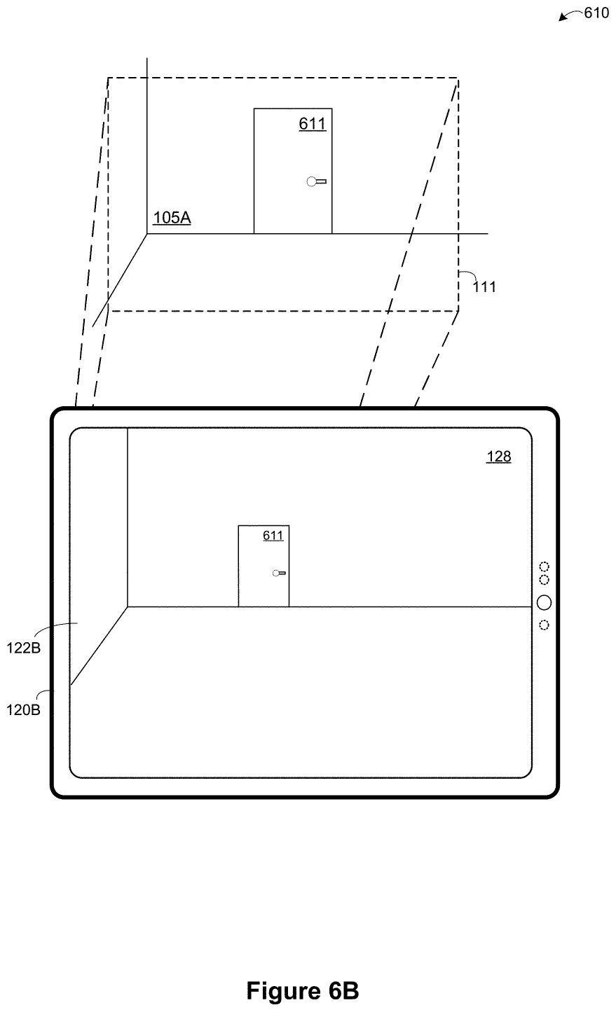

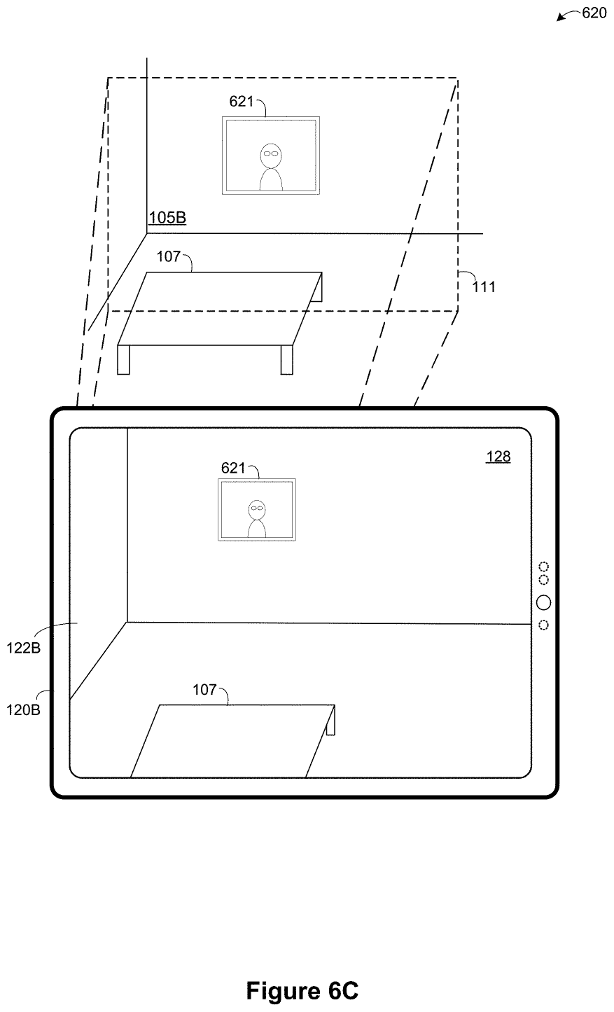

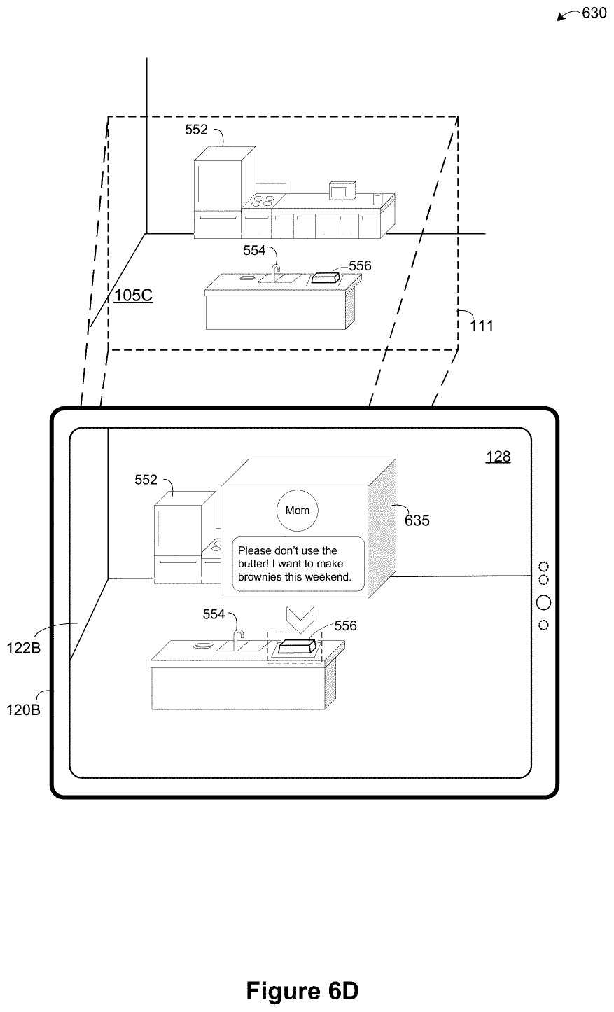

As shown in FIG. 5B, during the instance 510A (e.g., associated with time T1), in response to detecting the selection input 505 in FIG. 5A, the first electronic device 120A presents, via the display 122A, an electronic message thread interface 511 associated with the electronic message thread 504A between the first user of the first electronic device 120A and a second user (e.g., Albert) of a second electronic device 120B (e.g., illustrated in FIGS. 6A-6D). As shown in FIG. 5B, the electronic message thread interface 511 includes pre-existing electronic messages 514A, 514B, and 514C associated with the electronic message thread 504A and an empty composition field 512 for composing a new electronic message. According to some implementations, the first user of the first electronic device 120A may enter an alphanumeric string into the composition field 512 via a software (SW) keyboard 515, voice commands/inputs, or by selecting one of a first plurality of predictive affordances 516A, 516B, or 516C (e.g., autofill text strings such as recently, frequently, etc. used text strings based on the current context—the empty composition field 512).

As shown in FIG. 5C, during the instance 520A (e.g., associated with time T2), the first electronic device 120A presents, via the display 122A, a first alphanumeric string 522A (e.g., “Please don't use the butter!”) within the composition field 512, which, for example, was entered by the first user via the SW keyboard 515 prior to time T2. As shown in FIG. 5C, the first electronic device 120A also presents a send affordance 526, which, when selected (e.g., with a finger contact, a tap gesture, etc.), causes the first electronic device 120A to send the new electronic message within the composition field 512 to the recipient (e.g., the second user—Albert).

As shown in FIG. 5C, the first electronic device 120A further presents a second plurality of predictive affordances 524A, 524B, or 524C based on the content, context, etc. of the first alphanumeric string 522A. For example, the predictive affordance 524C corresponds to an option to add an attachment flag or metadata to the new electronic message associated with a real-world object (e.g., “butter” as mentioned in the first alphanumeric string 522A). Continuing with this example, the predictive affordances 524A and 524B correspond to autofill text strings such as recently, frequently, etc. used text strings based on the current context—the first alphanumeric string 522A within the composition field 512. One of ordinary skill in the art will appreciate that the attachment flag or metadata associated with the real-world object may be added to the new electronic message by other means in various other implementations such as via a voice command or the like.

Furthermore, as shown in FIG. 5C, the first electronic device 120A detects a selection input 525 directed the predictive affordance 524C. For example, in response to detecting the selection input 525 directed the predictive affordance 524C in FIG. 5C, the first electronic device 120A adds the attachment flag or metadata to the new electronic message associated with the real-world object (e.g., “butter” as mentioned in the first alphanumeric string 522A).

As shown in FIG. 5D, during the instance 530A (e.g., associated with time T3), the first electronic device 120A presents, via the display 122A, a second alphanumeric string 522B (e.g., “Please don't use the butter! I want to make brownies this weekend.”) within the composition field 512, which, for example, was entered by the first user via the SW keyboard 515 prior to time T3. As shown in FIG. 5D, the first electronic device 120A also presents the first plurality of predictive affordances 516A, 516B, or 516C within the electronic message thread interface 511. As shown in FIG. 5D, the first electronic device 120A further detects a selection input 535 directed to the send affordance 526. For example, in response to detecting the selection input 535 directed to the send affordance 526 in FIG. 5D, the first electronic device 120A sends or transmits the new electronic message associated with the second alphanumeric string 522B within the composition field 512 to the recipient (e.g., the second user—Albert) or their associated electronic device (e.g., the second electronic device 120B shown in FIGS. 6A-6D).

As shown in FIG. 5E, during the instance 540A (e.g., associated with time T4), the first electronic device 120A presents, via the display 122A, the electronic message thread interface 511 associated with the electronic message thread 504A between the first user of the first electronic device 120A and the second user (e.g., Albert) of a second electronic device 120B (e.g., illustrated in FIGS. 6A-6D). As shown in FIG. 5E, the electronic message thread interface 511 includes the electronic messages 514B, 514C, and 514D associated with the electronic message thread 504A and the empty composition field 512 for composing a new electronic message. For example, the electronic message 514D corresponds to the new electronic message sent to the recipient (e.g., the second user—Albert) in response to detecting the selection input 535 directed to the send affordance 526 in FIG. 5D. Continuing with this example, the electronic message 514D includes the second alphanumeric string 522B and an attachment indicator 542 such as text indicating that the electronic message 514D includes an attachment flag or metadata associated with the real-world object (e.g., “butter”). In some implementations, the attachment indicator 542 may not be shown.

FIGS. 5F-5J illustrate a second sequence of instances 500B-540B associated with sending an electronic message associated with a real-world object in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, the sequence of instances 500B-540B are rendered and presented by a first electronic device 120A associated with a first user (e.g., the sender) that includes a display 122A. For example, the first electronic device 120A is similar to and adapted from the electronic device 120 described with reference to FIGS. 1, 3, and 5A-5E. As such, similar reference numbers are used between FIGS. 1, 3, 5A-5E, and 5F-5J and only the differences therebetween will be discussed for the sake of brevity.

As shown in FIGS. 5F-5J, the electronic device 120A presents the XR environment 128 via a display 122A to the first user while physically present within a physical environment 105C (e.g., a kitchen) that includes a refrigerator 552, a sink 554, and a stick of butter 556, which are currently within the FOV 111 of an exterior-facing image sensor of the electronic device 120A. As such, in some implementations, the first user holds the electronic device 120A in their hand(s) similar to the operating environment 100 in FIG. 1.

In other words, in some implementations, the electronic device 120A is configured to present XR content and to enable optical see-through or video pass-through of at least a portion of the physical environment 105C via the display 122A. For example, the electronic device 120B corresponds to a mobile phone, tablet, laptop, near-eye system, wearable computing device, or the like.

As shown in FIG. 5F, during the instance 500B (e.g., associated with time T0), the first electronic device 120A presents, via the display 122A, the XR environment 128 including optical see-through or video pass-through of at least a portion of the physical environment 105C (e.g., the kitchen) via the display 122A such as the refrigerator 552, the sink 554, and the stick of butter 556. Furthermore, as shown in FIG. 5F, the first electronic device 120A detects a selection input 558, such as a gaze input, voice input, gesture input, touch input (e.g., a finger contact, a tap gesture, etc. detected via a touch-sensitive surface (TSS) integrated with the display 122A), or the like, directed to the butter 556 (or a representation thereof).

As shown in FIG. 5G, during the instance 510B (e.g., associated with time T1), in response to detecting the selection input 558 directed to the butter 556 (or a representation thereof) in FIG. 5F, the first electronic device 120A presents, via the display 122A, an interaction menu 562 associated with the butter 556 (or a representation thereof) and optionally presents a bounding box or frame surrounding the butter 556 (or the representation thereof). For example, the interaction menu 562 indicates “Butter selected!” due to detection of the selection input 558 directed to the butter 556 (or a representation thereof) in FIG. 5F. Furthermore, the interaction menu 562 includes: a selectable affordance 564A, which, when selected (e.g., with a selection input) causes option A to be performed on the butter 556 within the XR environment 128; a selectable affordance 564B, which, when selected (e.g., with a selection input) causes option B to be performed on the butter 556 within the XR environment 128; and a selectable affordance 564C, which, when selected (e.g., with a selection input) causes an electronic message interface 571 to be displayed within the XR environment 128 (e.g., as shown in FIG. 5H). Furthermore, as shown in FIG. 5G, the first electronic device 120A detects a voice input or a voice command 565 from the first user of the first electronic device 120A. For example, the voice input 565 corresponds to a selection input directed to the selectable affordance 564C (e.g., “Compose electronic message.” or “Select the bottom affordance.” or “Select the affordance 564C.”).

One of ordinary skill in the art will appreciate that the interaction menu 562 many include various other selectable affordances in addition to or in place of the selectable affordances 564A, 564B, and 564C in FIG. 5G in various implementations. One of ordinary skill in the art will appreciate that option A associated with the selectable affordance 564A and option B associated with the selectable affordance 564B may correspond to myriad operations, such as scaling, rotating, translating, etc. the selected object or changing the appearance of the selected object (e.g., texture, color, brightness, etc.), in various implementations.

As shown in FIG. 5H, during the instance 520B (e.g., associated with time T2), in response to detecting the voice input 565 in FIG. 5G, the first electronic device 120A presents, via the display 122A, a software (SW) keyboard 515 and an electronic message interface 571 for composing an electronic message to the second user (e.g., Albert). One of ordinary skill in the art will appreciate that the first user may select one or more recipients from an address book or a directory of names, manually input recipient information, or the like in various implementations. As shown in FIG. 5H, the electronic message interface 571 includes an empty composition field 512 for composing a new electronic message. According to some implementations, the first user of the first electronic device 120A may enter an alphanumeric string into the composition field 512 via the SW keyboard 515.

As shown in FIG. 5I, during the instance 530B (e.g., associated with time T3), the first electronic device 120A presents, via the display 122A, an alphanumeric string 572 (e.g., “Please don't use the butter! I want to make brownies this weekend.”) within the composition field 512, which, for example, was entered by the first user via the SW keyboard 515 prior to time T3. As shown in FIG. 5I, the first electronic device 120A also presents a send affordance 526 within the electronic message interface 571, which, when selected (e.g., with a selection input), causes the first electronic device 120A to send the new electronic message within the composition field 512 to the recipient (e.g., the second user—Albert). Furthermore, as shown in FIG. 5I, the first electronic device 120A detects a selection input 574, such as a gaze input, voice input, gesture input, touch input (e.g., a finger contact, a tap gesture, etc. detected via a touch-sensitive surface (TSS) integrated with the display 122A), or the like, directed to the send affordance 526.

As shown in FIG. 5J, during the instance 540B (e.g., associated with time T4), the first electronic device 120A presents, via the display 122A, an electronic message 514D within the electronic message interface 571 that corresponds to the new electronic message sent to the recipient (e.g., the second user—Albert) in response to detecting the selection input 574 directed to the send affordance 526 in FIG. 5I. Continuing with this example, the electronic message 514D includes the alphanumeric string 572 and an attachment indicator 542 such as text indicating that the electronic message 514D includes an attachment flag or metadata associated with the real-world object (e.g., “butter”). In some implementations, the attachment indicator 542 may not be shown.

FIG. 6A illustrates an instance 600 associated with receiving an electronic message associated with a real-world object in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, the instance 600 is rendered and presented by a second electronic device 120B associated with a second user (e.g., the recipient) that includes a display 122B. For example, the second electronic device 120B is similar to and adapted from the electronic device 120 described with reference to FIGS. 1 and 3. As such, similar reference numbers are used between FIGS. 1, 3, and 6A-6D and only the differences therebetween will be discussed for the sake of brevity.

As shown in FIG. 6A, during the instance 600 (e.g., associated with time T5), the second electronic device 120B presents, via the display 122B, a lock-screen interface 602 including the electronic message 514D sent by the first user in FIG. 5E or in FIG. 5J. In FIG. 6A, the electronic message 514D includes the second alphanumeric string 522B (e.g., “Please don't use the butter! I want to make brownies this weekend.”) and the attachment indicator 542 such as text indicating that the electronic message 514D includes an attachment flag or metadata associated with the real-world object (e.g., “butter”). In some implementations, the attachment indicator 542 may not be shown.

FIG. 6B-6D illustrate a sequence of instances 610-630 associated with surfacing an extended reality (XR) object that corresponds to the electronic message in association with the real-world object in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, the sequence of instances 610-630 are rendered and presented by a computing system such as the controller 110 shown in FIGS. 1 and 2; the electronic device 120 shown in FIGS. 1 and 3; and/or a suitable combination thereof.

As shown in FIGS. 6B, the electronic device 120B presents the XR environment 128 via a display 122B to the second user while physically present within a physical environment 105A that includes a door 611, which is currently within the FOV 111 of an exterior-facing image sensor of the electronic device 120B. As such, in some implementations, the second user holds the electronic device 120B in their hand(s) similar to the operating environment 100 in FIG. 1.

In other words, in some implementations, the electronic device 120B is configured to present XR content and to enable optical see-through or video pass-through of at least a portion of the physical environment 105A via the display 122B (e.g., the door 611). For example, the electronic device 120B corresponds to a mobile phone, tablet, laptop, near-eye system, wearable computing device, or the like.

As shown in FIG. 6B, during the instance 610 (e.g., associated with time T6), the electronic device 120B presents an XR environment 128 including optical see-through or video pass-through of at least a portion of the physical environment 105A (e.g., an empty room, a foyer, or a hallway) via the display 122B such as the door 611. According to some implementations, in response to receiving the electronic message 514D with the attachment flag or the metadata associated with the real-world object (e.g., “butter”), the electronic device 120B determines whether the FOV 111 of the physical environment 105A includes the real-world object (e.g., “butter”) by performing object recognition, instance segmentation, semantic segmentation, etc. on images associated with the FOV 111 of the physical environment 105A captured by one or more exterior-facing images sensors of the electronic device 120B and/or one or more remote image sensors.

In some implementations, the metadata associated with the real-world object may identify the type of object to which the XR object corresponding to the electronic message should be attached, and the receiving device (e.g., the electronic device 120B) may perform one of the computer-vision techniques described above to detect or identify an object matching that type. In some implementations, the metadata associated with the real-world object may include location data of the real-world object such that the receiving device (e.g., the electronic device 120B) may only present the XR object corresponding to the electronic message when the object is detected at or near a location associated with the location data. In other implementations, the metadata associated with the real-world object may include data that identifies a specific instance of the object to which the XR object corresponding to the electronic message should be attached such as images of the object, a 3D model of the object, feature descriptors of the object, or the like.

In accordance with the determination that the FOV 111 of the physical environment 105A includes the real-world object (e.g., “butter”), the electronic device 120B presents an XR object corresponding to the electronic message 514D in association with the real-world object. In accordance with the determination that the FOV 111 of the physical environment 105A does not include the real-world object (e.g., “butter”), the electronic device 120B foregoes presentation of the XR object corresponding to the electronic message 514D in association with the real-world object. As shown in FIG. 6B, the FOV 111 of the physical environment 105A does not include the real-world object indicated by the electronic message 514D (e.g., “butter”) so the electronic device 120B does not present the XR object in association with the real-world object.

As shown in FIG. 6C, during the instance 620 (e.g., associated with time T7), the electronic device 120B presents the XR environment 128 including optical see-through or video pass-through of at least a portion of a physical environment 105B (e.g., a sitting room, a den, or the like) via the display 122B such as the table 107 and a portrait 621. As shown in FIG. 6C, the FOV 111 of the physical environment 105B does not include real-world object indicated by the electronic message 514D (e.g., “butter”) so the electronic device 120B does not present the XR object in association with the real-world object.

As shown in FIG. 6D, during the instance 630 (e.g., associated with time T8), the electronic device 120B presents the XR environment 128 including optical see-through or video pass-through of at least a portion of a physical environment 105C (e.g., a kitchen) via the display 122B such as a refrigerator 552, a sink 554, and a stick of butter 556. As shown in FIG. 6C, the FOV 111 of the physical environment 105B includes a real-world object indicated by the electronic message 514D (e.g., “butter”). In accordance with the determination that the FOV 111 of the physical environment 105C includes the real-world object (e.g., “butter”) indicated by the electronic message 614D, as shown in FIG. 6D, the electronic device 120B presents an XR object 635 corresponding to the electronic message 514D in association with the stick of butter 556. For example, the XR object 635 in FIG. 6D corresponds to a two-dimensional (2D), a three-dimensional (3D), or a volumetric object presented nearby the stick of butter 556 with similar text to the electronic message 514D. For example, in FIG. 6D, the XR object 635 is overlaid on the physical environment 105C within the XR environment 128. As such, according to some implementations, the XR object 635 acts a reminder to do or not to do a task or action associated with the stick of butter 556.

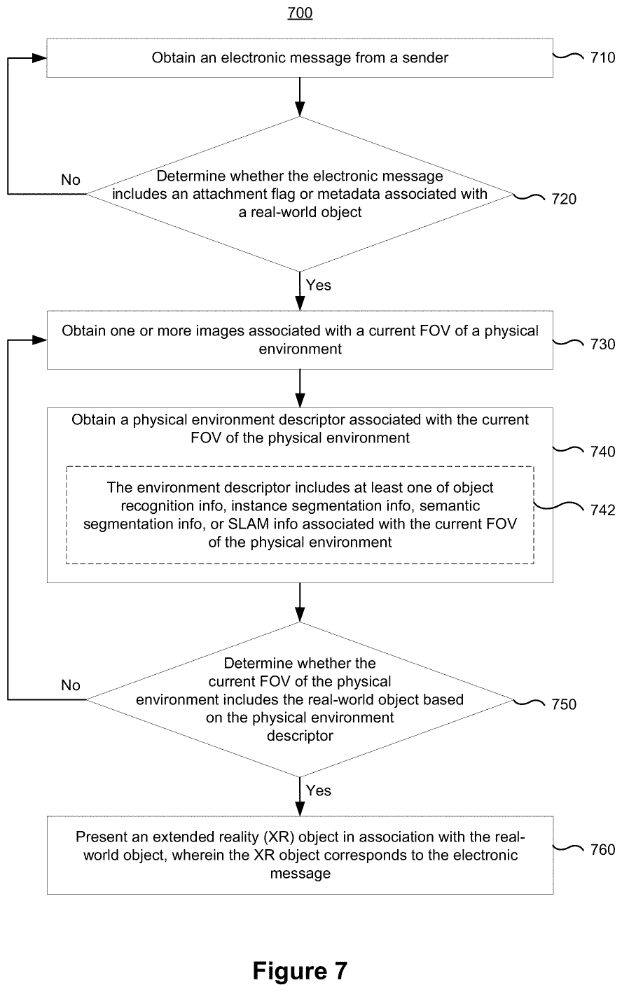

FIG. 7 illustrates a flowchart representation of a method 700 of surfacing an extended reality (XR) object corresponding to an electronic message with some implementations. In various implementations, the method 700 is performed at a computing system including non-transitory memory and one or more processors, wherein the computing system is communicatively coupled to a display device and one or more input devices (e.g., the electronic device 120 shown in FIGS. 1 and 3; the controller 110 in FIGS. 1 and 2; or a suitable combination thereof). In some implementations, the method 700 is performed by processing logic, including hardware, firmware, software, or a combination thereof. In some implementations, the method 700 is performed by a processor executing code stored in a non-transitory computer-readable medium (e.g., a memory). In some implementations, the computing system corresponds to one of a tablet, a laptop, a mobile phone, a near-eye system, a wearable computing device, or the like. In some implementations, the one or more input devices correspond to a computer vision (CV) engine that uses an image stream from one or more exterior-facing image sensors, a finger/hand/extremity tracking engine, an eye tracking engine, a touch-sensitive surface, one or more microphones, and/or the like.

As discussed above, ordinary text messages or emails that include instructions associated with a real-world object are not self-executory and, instead, rely on the reading comprehension and memory retention of the recipient to carry out the instructions. As such, ordinary text messages or emails are disassociated from the real-world or physical object. According to the implementations described herein, while composing an electronic message, a sender may include an attachment flag or metadata associated with a real-world object. In turn, the electronic message may be presented to the recipient in a 2D user interface (e.g., as a typical banner or pop-up notification) and an XR object corresponding to the electronic message may also be presented to the recipient when the associated real-world object or physical object is recognized or detected within the current FOV of a physical environment. As such, according to some implementations, the XR object acts a reminder to do or not to do a task or action associated with the real-world object or physical object. In this way, the electronic message with the attachment flag or metadata associated with the real-world object is no longer disassociated from the real-world object.

As represented by block 710, the method 700 includes obtaining (e.g., receiving, retrieving, or the like) an electronic message from a sender. For example, the electronic message corresponds to an SMS, an MMS, an email, a social media message, a chat message, or the like. As one example, with reference to FIG. 2, the controller 110 or a component thereof (e.g., the data obtainer 242) receives the electronic message via the one or more communication interfaces 208. As another example, with reference to FIG. 3, the electronic device 120 or a component thereof (e.g., the data obtainer 342) receives the electronic message via the one or more communication interfaces 308.

In some implementations, in response to obtaining the electronic message, the method 700 includes presenting, via the display device, a two-dimensional (2D) representation of the electronic message. For example, the 2D representation of the electronic message is presented within a 2D interface associated with a messaging application or is presented within a 2D OS interface as a banner or pop-up notification. As one example, in FIG. 6A, the second electronic device 120B presents, via the display 122B, a lock-screen interface 602 including the electronic message 514D sent by the first user in FIG. 5E in a 2D notification form. In FIG. 6A, the electronic message 514D includes the second alphanumeric string 522B (e.g., “Please don't use the butter! I want to make brownies this weekend.”) and the attachment indicator 542 such as text indicating that the electronic message 514D includes an attachment flag or metadata associated with the real-world object (e.g., “butter”).

As represented by block 720, the method 700 includes determining whether the electronic message includes an attachment flag or metadata associated with a real-world object. In accordance with a determination that the electronic message includes the attachment flag or the metadata associated with the real-world object, the method 700 continues to block 730. In accordance with a determination that the electronic message does not include the attachment flag or the metadata associated with the real-world object, the method 700 continues to block 710 (e.g., the computing system waits for a next incoming electronic message). As one example, with reference to FIGS. 2 and 4C, in response to obtaining an electronic message, the computing system or a component thereof (e.g., the surfacer engine 439) is configured to determine whether the electronic message includes an attachment flag or metadata indicating that the electronic message is attached to or associated with a particular real-world object.

In some implementations, the real-world object corresponds to a food item, an article of clothing, a tool, a decorative item, or a household item. For example, the real-world object corresponds to a stick of butter, a carton of eggs, a jug of milk, a loaf of bread, a bunch of bananas, or the like. For example, with reference to FIG. 6A, the electronic device 120B presents the electronic message 514D sent by the first user in FIG. 5E, which includes the second alphanumeric string 522B (e.g., “Please don't use the butter! I want to make brownies this weekend.”) and the attachment indicator 542 such as text indicating that the electronic message 514D includes an attachment flag or metadata associated with the real-world object (e.g., “butter”).

As represented by block 730, in accordance with a determination that the electronic message includes the attachment flag or the metadata associated with the real-world object, the method 700 includes obtaining (e.g., receiving, retrieving, or capturing) one or more images associated with a current field-of-view (FOV) of a physical environment. As one example, with reference to FIGS. 2 and 4A, the computing system or a component thereof (e.g., the environment analyzer 416) obtains the local sensor data 403 and/or the remote sensor data 405 after it has been subjected to the privacy architecture 408. In this example, the local sensor data 403 may include images or a stream thereof associated with a current FOV of one or more exterior-facing image sensors of the electronic device 120 (e.g., the image capture device 370 in FIG. 3) relative to the physical environment 105. Similarly, continuing with this example, the remote sensor data 405 may include images or a stream thereof associated with a current FOV of optional remote input devices within the physical environment 105 relative to the physical environment 105.

As represented by block 740, the method 700 includes obtaining (e.g., receiving, retrieving, or determining/generating) a physical environment descriptor associated with the current FOV of the physical environment. In some implementations, as represented by block 742, the physical environment descriptor includes at least one of object recognition information, instance segmentation information, semantic segmentation information, SLAM information, or the like associated with the current FOV of the physical environment.

As one example, with reference to FIGS. 2 and 4A, the computing system or a component thereof (e.g., the environment analyzer 416) obtains (e.g., receives, retrieves, or determines/generates) an environment descriptor 445 based on the input data (e.g., the local sensor data 403 and the remote sensor data 405) and updates the environment descriptor 445 over time. FIG. 4B illustrates the example environment descriptor 445 including the timestamp 461 (e.g., the most recent time the environment descriptor 445 was updated), the object recognition information 462 associated with physical objects recognized within the physical environment 105 (e.g., based on a classification algorithm, computer vision (CV) techniques, or the like), the instance segmentation information 464A associated with the physical environment 105, the semantic segmentation information 464B such as labels for physical objects recognized or detected within the physical environment 105, the SLAM information 466 associated with the physical environment 105 (e.g., a map, a mesh, a point cloud, or the like for the physical environment 105 as well as the current location of the electronic device 120 therewithin), and/or miscellaneous information 468.

As represented by block 750, the method 700 includes determining whether the current FOV of the physical environment includes the real-world object based on the physical environment descriptor. In accordance with a determination that the current FOV of the physical environment includes the real-world object, the method 700 continues to block 760. In accordance with a determination that the current FOV of the physical environment does not include the real-world object, the method 700 continues to block 730 (e.g., the computing system continues obtaining images(s) associated with the current FOV of the physical environment. As one example, with reference to FIGS. 2 and 4C, in response to determining that the electronic message is attached to or associated with the real-world object, the computing system or a component thereof (e.g., the surfacer engine 439) is configured to determine whether a current FOV of the physical environment 105 includes the real-world object.

In some implementations, the computing system determines whether the current FOV includes the real-world object while an associated messaging application is running in the foreground or background. In some implementations, the computing system continuously determines whether the current FOV includes the real-world object. In some implementations, the computing system determines whether the current FOV includes the real-world object every X seconds.

In some implementations, the computing system determines whether the current FOV includes the real-world object until the electronic message (or the XR object presented in association with the real-world object) is marked as read, dismissed, deleted, or the like. For example, the second user may manually mark the electronic message (or the XR object presented in association with the real-world object) as read. As another example, the second user may manually dismiss (e.g., with a gesture, voice input, or the like) the electronic message (or the XR object presented in association with the real-world object). As another example, the computing system may mark the electronic message (or the XR object presented in association with the real-world object) as read if the gaze vector is directed to the electronic message (or the XR object presented in association with the real-world object) for at least Y seconds. Furthermore, in some implementations, the computing system determines whether the current FOV includes the real-world object after an associated electronic message is transitioned from a read state to an unread state. For example, the second user may manually mark an already read electronic message as unread.

In some implementations, the computing system determines whether the current FOV includes the real-world object by performing an object classification technique to identify an object within the current FOV of the physical environment that matches a particular type of the real-world object (e.g., object recognition, semantic segmentation, or the like) when the electronic message includes metadata indicating the particular type of the real-world object. In some implementations, the computing system determines whether the current FOV includes the real-world object by performing an object detection technique using a representation of the real-world object when the electronic message includes metadata indicating the representation of the real-world object. For example, the representation of the real-world object corresponds to a 3D model, an image, feature descriptors, or the like.

In some implementations, the computing system determines whether the current FOV includes the real-world object by determining whether an object in the current FOV is situated at a location corresponding to a specific location of the real-world object when the electronic message includes metadata indicating the specific location of the real-world object. According to some implementations, assuming the metadata includes a location for the real-world object, the computing may determine whether the current FOV of the physical environment includes the real-world object when the computing system is within Z m or A cm of the location. As one example, if the electronic message indicates “Do not drink the milk in the fridge!”, the computing system will not waste resources determining whether the current FOV of the physical environment includes the real-world object (e.g., the milk) until the computing system is within Z m or A cm of the refrigerator of the sender or recipient. As another example, if the electronic message indicates “Please water my split leaf philodendron.”, the computing system will not waste resources determining whether the current FOV of the physical environment includes the real-world object (e.g., split leaf philodendron) until the computing system is within Z m or A cm of the split leaf philodendron mentioned in the electronic message

As represented by block 760, in accordance with a determination that the current FOV of the physical environment includes the real-world object, the method 700 includes presenting, via the display device, an extended reality (XR) object in association with the real-world object, wherein the XR object corresponds to the electronic message. As one example, with reference to FIGS. 2 and 4C, in accordance with a determination that the current FOV of the physical environment 105 includes the real-world object, the computing system or a component thereof (e.g., the surfacer engine 439) is configured to cause the rendering engine 450 to surface or present an XR object within the XR environment 128 that corresponds to the electronic message in association with the real-world object (e.g., a physical object). As one example, in accordance with the determination that the FOV 111 of the physical environment 105C includes the real-world object (e.g., “butter”) indicated by the electronic message 614, as shown in FIG. 6D, the electronic device 120B presents an XR object 635 corresponding to the electronic message 514D in association with the stick of butter 556. As such, according to some implementations, the XR object 635 acts a reminder to do or not to do a task or action associated with the stick of butter 556.

In some implementations, if the current FOV includes the real-world object when the electronic message is received, the computing system may forgo presenting the two-dimensional version of the electronic message (or the notification associated therewith) and present the XR object in association with the real-world object. In some implementations, if the current FOV includes the real-world object when the electronic message is received, the computing system may concurrently present the two-dimensional version of the electronic message (or the notification associated therewith) and the XR object in association with the real-world object.

According to some implementations, the user of the computing system may modify or otherwise interact with the XR object within the XR environment. For example, the computing system may detect one or more user inputs from the user that correspond to changing an appearance of the XR object such as its color, texture, brightness, size, shape, or the like. As another example, computing system may detect one or more user inputs from the user that correspond to scaling, translating, rotating, etc. the XR object.

In some implementations, the display device corresponds to a transparent lens assembly, and wherein presenting the XR environment or the XR object includes projecting the XR environment or the XR object onto the transparent lens assembly. In some implementations, the display device corresponds to a near-eye system, and wherein presenting the XR environment or the XR object includes compositing the XR environment or the XR object with one or more images of a physical environment captured by an exterior-facing image sensor.

In some implementations, the XR object corresponds to XR content that is object-locked to the real-world object. For example, the XR object is locked to the location of the real-world object (e.g., a spatial offset relative to the location of the real-world object or overlaid on the real-world object). In some implementations, presenting the XR object in association with the real-world object includes one of: presenting the XR object overlaid on the real-world object or presenting the XR object adjacent to the real-world object. For example, the XR object 635 in FIG. 6D corresponds to a volumetric or three-dimensional (3D) object presented nearby the stick of butter 556 within the XR environment 128 with similar text to the electronic message 514D. For example, in FIG. 6D, the XR object 635 is overlaid on the physical environment 105C within the XR environment 128.

In some implementations, in accordance with a determination that the current FOV does not include the real-world object, the method 700 includes forgoing presentation of the XR object in association with the real-world object and continuing obtaining images(s) associated with the current FOV of the physical environment (e.g., loop back to the block 730). As one example, in FIG. 6B, the FOV 111 of the physical environment 105A does not include the real-world object indicated by the electronic message 514D (e.g., “butter”) so the electronic device 120B does not present the XR object in association with the real-world object. As another example, in FIG. 6C, the FOV 111 of the physical environment 105B does not include real-world object indicated by the electronic message 514D (e.g., “butter”) so the electronic device 120B does not present the XR object in association with the real-world object.

In some implementations, the method 700 further includes: composing a subsequent electronic message including an attachment flag or metadata associated with a different real-world object; and transmitting the subsequent electronic message to a recipient. FIGS. 5A-5E, for example, illustrate a sequence of instances 500-540 associated with sending an electronic message 514D associated with a real-world object (e.g., butter) from a sender (e.g., the first user associated with the first electronic device 120A) to a recipient (e.g., the second user associated with the second electronic device 120B— Albert). One of ordinary skill in the art will appreciate that the second user associated with the second electronic device 120B may similarly compose and send a subsequent electronic message associated with the same real-world object or a different real-world object to the first user associated with the first electronic device 120A or a different user.

In some implementations, the metadata included within the subsequent electronic message corresponds to an attachment flag associated with the different real-world object. In some implementations, the metadata included within the subsequent electronic message indicates a type or classification of the different real-world object. In some implementations, the metadata included within the subsequent electronic message indicates a representation or a model of the different real-world object (e.g., images of the object, a 3D model of the object, feature descriptors of the object, or the like). In some implementations, the metadata included within the subsequent electronic message indicates a location of the different real-world object.

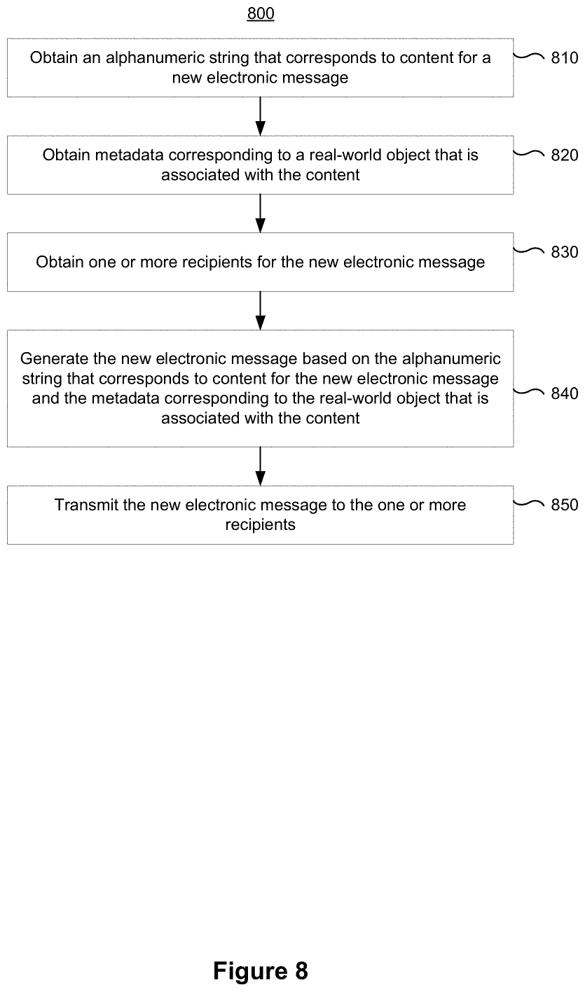

FIG. 8 illustrates a flowchart representation of a method 800 of sending an electronic message associated with a real-world object in accordance with some implementations. In various implementations, the method 800 is performed at a computing system including non-transitory memory and one or more processors, wherein the computing system is communicatively coupled to a display device and one or more input devices (e.g., the electronic device 120 shown in FIGS. 1 and 3; the controller 110 in FIGS. 1 and 2; or a suitable combination thereof). In some implementations, the method 800 is performed by processing logic, including hardware, firmware, software, or a combination thereof. In some implementations, the method 800 is performed by a processor executing code stored in a non-transitory computer-readable medium (e.g., a memory). In some implementations, the computing system corresponds to one of a tablet, a laptop, a mobile phone, a near-eye system, a wearable computing device, or the like. In some implementations, the one or more input devices correspond to a computer vision (CV) engine that uses an image stream from one or more exterior-facing image sensors, a finger/hand/extremity tracking engine, an eye tracking engine, a touch-sensitive surface, one or more microphones, and/or the like.

As represented by block 810, the method 800 includes obtaining (e.g., receiving, retrieving, detecting, generating, etc.) an alphanumeric string that corresponds to content for a new electronic message. In some implementations, the alphanumeric string is obtained based on one or more user interactions with a physical keyboard or a software keyboard. In some implementations, the alphanumeric string is obtained based on a voice input. As one example, with reference to FIGS. 5A-5E, the first user composes an electronic message 514D that includes an attachment flag 542 or metadata associated with the real-world object (e.g., “butter”) by entering the second alphanumeric string 522B into the empty composition field 512 via the SW keyboard 515. As another example, with reference to FIGS. 5F-5J, the first user composes an electronic message 514D that includes an attachment flag 542 or metadata associated with the real-world object (e.g., “butter”) by entering the alphanumeric string 572 into the empty composition field 512 via the SW keyboard 515.

As represented by block 820, the method 800 includes obtaining (e.g., receiving, retrieving, detecting, generating, etc.) metadata corresponding to a real-world object that is associated with the content. In some implementations, the metadata corresponds to an attachment flag associated with the real-world object. In some implementations, the metadata indicates a type or classification of the real-world object. In some implementations, the metadata indicates a representation or a model of the real-world object. In some implementations, the metadata indicates a location of the real-world object.

According to some implementations, the method 800 includes determining a real-world location for the real-world object, wherein the metadata associated with the real-world object includes the real-world location for the real-world object. As one example, in response to detecting the selection input 558 directed to the butter 556 in FIG. 5F, the first electronic device 120A determines a location for the butter 556 relative to world coordinates or relative to a coordinate system associated with the physical environment 105C (e.g., based on SLAM technique(s) or the like). As another example, in response to detecting the voice input 565 directed to selecting the selectable affordance 564C in FIG. 5G, the first electronic device 120A determines a location for the butter 556 relative to world coordinates or relative to a coordinate system associated with the physical environment 105C (e.g., based on SLAM technique(s) or the like).

According to some implementations, the method 800 includes: presenting, via the display device, a representation of a physical environment; and detecting, via the one or more input devices, a selection input directed to a representation of the real-world object within the representation of the physical environment. In some implementations, in response to detecting the selection input directed to the representation of the real-world object, the method 800 includes determining a real-world location for the real-world object and determining a classification for the real-world object, wherein the metadata associated with the real-world object includes the real-world location for the real-world object and the classification for the real-world object. As one example, in FIG. 5F, the first electronic device 120A presents, via the display 122A, the XR environment 128 including optical see-through or video pass-through of at least a portion of the physical environment 105C (e.g., the kitchen) via the display 122A such as the refrigerator 552, the sink 554, and the stick of butter 556. Furthermore, as shown in FIG. 5F, the first electronic device 120A detects a selection input 558, such as a gaze input, voice input, gesture input, touch input (e.g., a finger contact, a tap gesture, etc. detected via a touch-sensitive surface (TSS) integrated with the display 122A), or the like, directed to the butter 556 (or a representation thereof). In this example, in response to detecting the selection input 558 directed to the butter 556 (or the representation thereof), the first electronic device 120A determines a location for the butter 556 (or the representation thereof) relative to world coordinates or relative to a coordinate system associated with the physical environment 105C (e.g., based on SLAM technique(s) or the like) and a classification, an object type, a semantic label, or the like for the butter 556 (or the representation thereof).

According to some implementations, the method 800 includes: presenting, via the display device, a representation of a physical environment; detecting, via the one or more input devices, a gaze vector directed to a representation of the real-world object within the representation of the physical environment; while detecting the gaze vector directed to the representation of the real-world object within the representation of the physical environment: detecting a voice input that corresponds to the alphanumeric string and the one or more recipients; and in response to detecting the voice input, determining a classification for the real-world object while the gaze vector remains directed to the representation of the real-world object within the representation of the physical environment, wherein the metadata associated with the real-world object includes the classification for the real-world object.

As one example, in FIG. 5F, the first electronic device 120A presents, via the display 122A, the XR environment 128 including optical see-through or video pass-through of at least a portion of the physical environment 105C (e.g., the kitchen) via the display 122A such as the refrigerator 552, the sink 554, and the stick of butter 556. Continuing with this example, in place of detecting the selection input 558, the electronic device 120A detects a gaze vector directed to the butter 556 within the XR environment 128. While detecting the gaze vector directed to the butter 556 within the XR environment 128, in this example, the electronic device 120A detects a voice input that corresponds to the alphanumeric string and the one or more recipients. In response to detecting the voice input, in this example, the electronic device 120A determines a classification, an object type, a semantic label, or the like for the butter 556 while the gaze vector remains directed to the butter 556 within the XR environment 128.

According to some implementations, the method 800 includes: generating one or more options for the metadata associated with the real-world object based on the alphanumeric string; presenting the one or more options for the metadata associated with the real-world object; detecting, via the one or more input devices, a selection input directed to a respective option among the one or more options for the metadata associated with the real-world object, and wherein obtaining the metadata associated with the real-world object includes selecting the respective option as the metadata associated with the real-world object in response to detecting the selection input directed to the respective option among the one or more options for the metadata associated with the real-world object. According to some implementations, the computing system generates one or more options for the metadata associated with the real-world object based on the alphanumeric string provided via a physical keyboard, a SW keyboard, a voice input, or the like.

As one example, with reference to FIGS. 5F-5J, the computing system performs object recognition, semantic segmentation, or the like on the representation of the physical environment 105C (e.g., the portion of the physical environment 105C within the FOV 111) to identify candidate objects within the physical environment 105C. Continuing with this example, the computing system presents one or more options for metadata associated with the candidate objects. For example, if candidate objects include objects A and B, the computing system may present or more options for metadata associated with objects A and B such as option 1 with metadata A for object A, option 2 with metadata B for object A, option 3 with metadata A for object B, and option 4 with metadata B for object B.

As another example, with reference to FIGS. 5F-5J, the computing system performs object recognition, semantic segmentation, or the like on the representation of the physical environment 105C (e.g., the portion of the physical environment 105C within the FOV 111) to identify candidate objects within the physical environment 105C. Continuing with this example, the computing system filters the candidate objects based on the alphanumeric string (e.g., removes candidate objects that are not germane to the alphanumeric string). In this example, assuming the alphanumeric string 572 (e.g., “Please don't use the butter! I want to make brownies this weekend.”), the computing system may filter out candidate objects that are not germane to the alphanumeric string 572 such as candidate objects that are unrelated to butter, brownies, or weekend.

As represented by block 830, the method 800 includes obtaining (e.g., receiving, retrieving, detecting, generating, etc.) one or more recipients for the new electronic message. In some implementations, the one or more recipients are obtained based on one or more user interactions with an address book or a directory of other users. In some implementations, the one or more recipients are obtained based on a voice input. As shown in FIGS. 5A-5E, for example, the first user composes a new electronic message 514D to Albert by selecting the electronic message thread 504A with the selection input 505 in FIG. 5A. As shown in FIG. 5F-5J, the first user composes a new electronic message 514D to Albert via the electronic message interface 571. One of ordinary skill in the art will appreciate that the first user may select one or more recipients from an address book or a directory of names, manually input recipient information, or the like in various implementations.

As represented by block 840, the method 800 includes generating the new electronic message based on the alphanumeric string that corresponds to content for the new electronic message and the metadata corresponding to the real-world object that is associated with the content. As represented by block 850, the method 800 includes transmitting the new electronic message to the one or more recipients. As one example, with reference to FIG. 5E, the first electronic device 120A presents, via the display 122A, an electronic message 514D within the electronic message thread interface 511 that corresponds to the new electronic message sent to the recipient (e.g., the second user—Albert) with the second alphanumeric string 522B and the attachment indicator 542, such as text indicating that the electronic message 514D includes an attachment flag or metadata associated with the real-world object (e.g., “butter”), in response to detecting the selection input 535 directed to the send affordance 526 in FIG. 5D. In some implementations, the attachment indicator 542 may not be shown.

As another example, with reference to FIG. 5J, the first electronic device 120A presents, via the display 122A, an electronic message 514D within the electronic message interface 571 that corresponds to the new electronic message sent to the recipient (e.g., the second user—Albert) with the alphanumeric string 572 and the attachment indicator 542, such as text indicating that the electronic message 514D includes an attachment flag or metadata associated with the real-world object (e.g., “butter”), in response to detecting the selection input 574 directed to the send affordance 526 in FIG. 5I. In some implementations, the attachment indicator 542 may not be shown.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first”, “second”, etc. may be used herein to describe various elements, these elements should not be limited by these terms. These terms are only used to distinguish one element from another. For example, a first media item could be termed a second media item, and, similarly, a second media item could be termed a first media item, which changing the meaning of the description, so long as the occurrences of the “first media item” are renamed consistently and the occurrences of the “second media item” are renamed consistently. The first media item and the second media item are both media items, but they are not the same media item.

The terminology used herein is for the purpose of describing particular implementations only and is not intended to be limiting of the claims. As used in the description of the implementations and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a computing system including non-transitory memory and one or more processors, wherein the computing system is communicatively coupled to a display device and one or more input devices via a communication interface:
obtaining an electronic message from a sender;
in response to determining that the electronic message is associated with a real-world object, determining whether a current field-of-view (FOV) of a physical environment includes the real-world object; and
in accordance with a determination that the current FOV of the physical environment includes the real-world object, presenting, via the display device, an extended reality (XR) object that corresponds to the electronic message in association with the real-world object.

2. The method of claim 1, further comprising:
in accordance with a determination that the current FOV does not include the real-world object, forgoing presentation of the XR object in association with the real-world object.

3. The method of claim 1, wherein the electronic message includes:
metadata indicating a type of the real-world object, and wherein determining whether the current FOV of the physical environment includes the real-world object comprises performing an object classification technique to identify an object matching the type of the real-world object;
metadata indicating a representation of the real-world object, and wherein determining whether the current FOV of the physical environment includes the real-world object comprises performing an object detection technique using the representation of the real-world object; or
metadata indicating a location of the real-world object, and wherein determining whether the current FOV of the physical environment includes the real-world object comprises determining whether an object in the current FOV is at a location corresponding to the location of the real-world object.

4. The method of claim 1, further comprising:
obtaining one or more images associated with the current FOV of the physical environment from one or more exterior-facing image sensors associated with the computing system;
obtaining a current physical environment descriptor characterizing the current FOV of the physical environment based on the one or more images; and
wherein determining whether the current FOV of the physical environment includes the real-world object includes determining whether the current physical environment descriptor characterizing the current FOV of the physical environment includes information associated with the real-world object.

5. The method of claim 1, wherein the XR object corresponds to XR content that is object-locked to the real-world object.

6. The method of claim 1, wherein presenting the XR object in association with the real-world object includes one of presenting the XR object overlaid on the real-world object or presenting the XR object adjacent to the real-world object.

7. The method of claim 1, further comprising:
in response to obtaining the electronic message, presenting, via the display device, a two-dimensional (2D) representation of the electronic message.

8. The method of claim 1, further comprising:
composing a subsequent electronic message including an attachment flag associated with a different real-world object; and
transmitting the subsequent electronic message to a recipient.

9. A device comprising:
one or more processors;
a non-transitory memory;
an interface for communicating with a display device and one or more input devices; and
one or more programs stored in the non-transitory memory, which, when executed by the one or more processors, cause the device to:
obtain an electronic message from a sender;
in response to determining that the electronic message is associated with a real-world object, determine whether a current field-of-view (FOV) of a physical environment includes the real-world object; and
in accordance with a determination that the current FOV of the physical environment includes the real-world object, present, via the display device, an extended reality (XR) object that corresponds to the electronic message in association with the real-world object.

10. The device of claim 9, wherein the one or more programs further cause the device to:
in accordance with a determination that the current FOV does not include the real-world object, forgo presentation of the XR object in association with the real-world object.

11. The device of claim 9, wherein the electronic message includes:
metadata indicating a type of the real-world object, and wherein determining whether the current FOV of the physical environment includes the real-world object comprises performing an object classification technique to identify an object matching the type of the real-world object;
metadata indicating a representation of the real-world object, and wherein determining whether the current FOV of the physical environment includes the real-world object comprises performing an object detection technique using the representation of the real-world object; or
metadata indicating a location of the real-world object, and wherein determining whether the current FOV of the physical environment includes the real-world object comprises determining whether an object in the current FOV is at a location corresponding to the location of the real-world object.

12. The device of claim 9, wherein the one or more programs further cause the device to:
obtain one or more images associated with the current FOV of the physical environment from one or more exterior-facing image sensors associated with the computing system;
obtain a current physical environment descriptor characterizing the current FOV of the physical environment based on the one or more images; and
wherein determining whether the current FOV of the physical environment includes the real-world object includes determining whether the current physical environment descriptor characterizing the current FOV of the physical environment includes information associated with the real-world object.

13. The device of claim 9, wherein the XR object corresponds to XR content that is object-locked to the real-world object.

14. The device of claim 9, wherein presenting the XR object in association with the real-world object includes one of presenting the XR object overlaid on the real-world object or presenting the XR object adjacent to the real-world object.

15. A non-transitory memory storing one or more programs, which, when executed by one or more processors of a device with an interface for communicating with a display device and one or more input devices, cause the device to:
obtain an electronic message from a sender;
in response to determining that the electronic message is associated with a real-world object, determine whether a current field-of-view (FOV) of a physical environment includes the real-world object; and
in accordance with a determination that the current FOV of the physical environment includes the real-world object, present, via the display device, an extended reality (XR) object that corresponds to the electronic message in association with the real-world object.

16. The non-transitory memory of claim 15, wherein the one or more programs further cause the device to:
in accordance with a determination that the current FOV does not include the real-world object, forgo presentation of the XR object in association with the real-world object.

17. The non-transitory memory of claim 15, wherein the electronic message includes:
metadata indicating a type of the real-world object, and wherein determining whether the current FOV of the physical environment includes the real-world object comprises performing an object classification technique to identify an object matching the type of the real-world object;
metadata indicating a representation of the real-world object, and wherein determining whether the current FOV of the physical environment includes the real-world object comprises performing an object detection technique using the representation of the real-world object; or
metadata indicating a location of the real-world object, and wherein determining whether the current FOV of the physical environment includes the real-world object comprises determining whether an object in the current FOV is at a location corresponding to the location of the real-world object.

18. The non-transitory memory of claim 15, wherein the one or more programs further cause the device to:
obtain one or more images associated with the current FOV of the physical environment from one or more exterior-facing image sensors associated with the computing system;
obtain a current physical environment descriptor characterizing the current FOV of the physical environment based on the one or more images; and
wherein determining whether the current FOV of the physical environment includes the real-world object includes determining whether the current physical environment descriptor characterizing the current FOV of the physical environment includes information associated with the real-world object.

19. The non-transitory memory of claim 15, wherein the XR object corresponds to XR content that is object-locked to the real-world object.

20. The non-transitory memory of claim 15, wherein presenting the XR object in association with the real-world object includes one of presenting the XR object overlaid on the real-world object or presenting the XR object adjacent to the real-world object.
